(19) United States
(12) Patent Application Publication
(10) Pub. No.: US 2026/0351858 A1
(43) Pub. Date: Nov. 5, 2026

(54) SYSTEM AND METHOD FOR A RECONFIGURABLE DELAY DETECTION NETWORK IN A METASURFACE TO DETECT UNAUTHORIZED INTERCEPTION OF REFLECTED RADIOFREQUENCY SIGNALS AND DYNAMICALLY CHANGING DELAY OF REFLECTED RADIOFREQUENCY SIGNALS

(71) Applicant: Dell Products LP, Round Rock, TX (US)

(72) Inventors: Harpreet S. Narula, Austin, TX (US); Tejinder Singh, Manotick (CA); Navjot Kaur Khaira, Manotick (CA)

(73) Assignee: Dell Products LP, Round Rock, TX (US)

(21) Appl. No.: 19/194,459

(22) Filed: Apr. 30, 2025

(51) Int. Cl. H01Q 15/00; H01Q 3/26; H04B 7/04

(52) U.S. Cl. CPC H01Q 15/0086; H01Q 3/2682; H04B 7/04013

(57) ABSTRACT

A metasurface unit cell array of a plurality of metasurface unit cells to manipulate reflection of incoming RF signals comprising a metasurface hardware controller executing code instructions of a metasurface hardware geofencing system to identify an angle of arrival of the incoming RF signals from consecutive metasurface unit cells to determine an expected phase delay of the incoming RF signals and compare it to a measured phase delay of the incoming RF signals from an reconfigurable delay detection network (RDDN) to identify a phase delay deviation indicating compromised integrity of the incoming RF signals. The metasurface hardware controller to detect the incoming RF signal from the RDDN and iteratively switch a switchable capacitive load at the RDDN to determine a corresponding a dynamic phase delay and introduce that dynamic phase delay into a reflected RF signal at the metasurface unit cells via a tunable varactor to secure wireless communication.

### FIELD OF THE DISCLOSURE

The present disclosure generally relates to metasurface systems for reflecting or directing radiofrequency signals used in wireless communications for information handling systems. The present disclosure more specifically relates systems and methods for a metasurface with an array of metasurface unit cells, including a reconfigurable delay detection network, to make a hardware-based determination of time phase delay for a received uplink radiofrequency (RF) signal that cannot be spoofed by an unauthorized device to identify the existence and location of such an unauthorized device within a geofence secured area.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities that may include wireless communications. The information handling system may be used to operate a wireless interface adapter and radio system for transmission of radio signals to a target receiving wireless device or access point device or to receive radio signals from the target wireless device or access point device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system wirelessly interfacing with a metasurface unit cell array with a metasurface hardware based geofencing system comprising a plurality of unit cells according to an embodiment of the present disclosure;

FIG. 2 is a block diagram illustrating a metasurface array with a metasurface hardware based geofencing system steering a wireless radio frequency (RF) transmission between a secure access point and an authorized endpoint information handling system according to an embodiment of the present disclosure;

FIG. 3 is graphical diagram illustrating a metasurface array with a metasurface hardware based geofencing system steering a wireless radio RF signal between a secure access point and an authorized endpoint information handling system according to an embodiment of the present disclosure;

FIG. 4 is graphical diagram illustrating a metasurface array of a plurality of metasurface unit cells for steering an incoming radiofrequency (RF) signal according to an embodiment of the present disclosure;

FIG. 5 is a graphical diagram illustrating a perspective view of a metasurface unit cell incorporating a substrate integrated waveguide for detecting an angle of arrival for incoming radiofrequency (RF) transmissions according to an embodiment of the present disclosure;

FIG. 6A is graphical diagram illustrating a top view of a metasurface unit cell of a metasurface array for reflecting a radiofrequency (RF) transmission according to an embodiment of the present disclosure;

FIG. 6B is graphical diagram illustrating a bottom view of a metasurface unit cell of a metasurface array for reflecting a radiofrequency (RF) transmission according to an embodiment of the present disclosure;

FIG. 7 is a graphical diagram of a reconfigurable delay determination network (RDDN) according to an embodiment of the present disclosure; and

FIG. 8 is a flow diagram illustrating a method for detecting differences between a time phase delay for an incoming RF uplink signal at a metasurface array that is estimated based upon transmission angle of arrival and a hardware-based measurement of transmission time phase delay according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Wireless data transmission from a transmitting device to a receiving device allows for rapid data transmission and communication between multiple devices. Devices may include wirelessly enabled information handling systems, access point devices, or any computing device, such as internet of things (IoT) devices that are wirelessly capable. As data transmission requirements increase, the electromagnetic (EM) wave (e.g., 5G technologies using 20 to 50 GHz wireless signals or WiFi 6 signals at 2.4 GHz, 5 GHz or even 6 GHz) used to transmit these ever-increasing amounts of data are shortened or may benefit from extended range such as reach around radiofrequency barriers such as walls. However, the ability to penetrate walls and building structures as well as transmit around these relatively large structures may be limited with such wireless systems. Additionally, material properties of these buildings and other structures affect reflection from, and transmission of, EM waves through building materials and on the absorption of EM wave energy in those materials, which gives rise to attenuation of the EM signal. Other EM wave-inhibiting mechanisms include diffraction from the edges of materials and scatter from rough edges also exist in radiofrequency environments such as rooms within a building. Further, most buildings behave as lossy dielectrics as building materials as well as occasionally conductive material that further inhibit or scatter EM wave propagation.

With the advent of massive multiple input multiple output (MIMO) wireless technologies, a group of antennas at both the transmitting device and receiving device may provide high spectral and energy efficient wireless communication systems. In an embodiment of the present disclosure, a series of thin surfaces or panels can be installed on building surfaces or other surfaces within a geofence secured radiofrequency environment that may be used to steer these EM waves and expand wireless range or signal quality. Some of these surfaces may include metasurface unit cells in arrays referred to as metasurface arrays or metasurface unit cell arrays in embodiments herein. The metasurface arrays of embodiments of the present disclosure may be used within current infrastructures having radiofrequency environments within, for example, office settings or home settings where radiofrequency data communication could benefit from these metasurfaces relaying EM wave transmissions around corners, into various office spaces, and/or into various rooms. In other words, a metasurface array placed in a known location and at a known reflection angle with respect to both a fixed-location access point and a fixed-location authorized endpoint information handling system may reflect RF signals received from one of these fixed locations directly to the other, even when an interference causing barrier (e.g., wall) is located in the direct line-of-sight path between those fixed locations. In other aspects of an embodiment, the metasurface arrays may be used to steer RF signals received from one of these fixed locations directly to the other even in the absence of such an obstruction as a means of securing the directionality of the transmission between two secured or authorized devices.

As metasurfaces become integral to wireless communication systems, they introduce both benefits and security risks. Traditional systems rely on encryption and secure protocols to protect data, but these measures often focus on securing the content rather than the transmission path. Unauthorized devices can exploit physical vulnerabilities, such as intercepting signals through authorized nearby devices or placing rogue access points, to gain unauthorized access to the RF signals within the geofenced area. This risk is exacerbated in environments with high-density networks or public access points, where monitoring and controlling all possible points of interception becomes impractical. In some cases of high-security areas, individuals may be issued badges with metasurfaces, or such devices may be attached to their laptops as a security measure. It is possible for an unauthorized device or its metasurface array to intercept a radio frequency (RF) uplink signal or a wireless link between the authorized metasurface and the access point (AP), or an RF downlink signal between the authorized metasurface and the authorized endpoint information handling system. A system is needed to ensure that unauthorized individuals or devices, or their metasurface can go only within allowed perimeters and flag any unauthorized device or its metasurface in an unauthorized area as a potential security risk.

The metasurface hardware based geofencing system in embodiments of the present disclosure address this issue by creating a security framework that integrates hardware-based angle of arrival detection via a substrate integrated waveguide (SIW) embedded within one or more metasurface unit cells of the metasurface array and hardware-based time phase delay detection via a reconfigurable delay detection network (RDDN) operably connected to one or more of such metasurface unit cells. In embodiments herein, these hardware-based security measures are not reliant solely on encryption and ensure that even if an unauthorized person gains physical proximity to the signal path, the metasurface hardware based geofencing system can detect and neutralize their efforts to intercept or manipulate the RF signal of a wireless link, offering a significant security advantage over conventional direct connection methods.

The SIWs in embodiments of the present disclosure couple a small portion of the incoming RF signal (e.g., either an uplink or downlink signal) via an electromagnetically coupled RF signal probe within the SIW to measure the phase shifts between consecutive metasurface unit cells. By analyzing these phase shifts, the hardware processor of the metasurface array executing code instructions of the metasurface hardware based geofencing system may determine the angle of arrival of the incoming RF signal. Based on this determined angle of arrival, the hardware processor of the metasurface array executing code instructions of the metasurface hardware based geofencing system may determine an expected time phase delay for reflection of that incoming RF signal from an authorized, secure access point or transmitter toward its intended target. If an unauthorized device attempts to manipulate the authorized metasurface to steer the RF signal of the wireless link toward itself, this may cause an additional time phase delay that does not match the expected time phase delay.

The metasurface hardware processor, such as a metasurface hardware controller, of the metasurface array executing code instructions of the metasurface hardware based geofencing system in embodiments herein may then make a hardware-based determination of the measured time phase delay for the incoming RF signal in order to detect any such additional and unexpected time phase delay. For example, the incoming RF uplink signal in embodiments herein may be fed down a reconfigurable delay detection network (RDDN) with known capacitance load at fixed transmission line segments across the RDDN. Capacitors within the RDDN may be loaded to known capacitance values in order to generate impedance at each junction of capacitors within the RF lines when the incoming RF uplink signal is fed from the electromagnetically coupled RF signal probe of the input of the reconfigurable delay detection network to an output pad. Upon feeding the incoming RF uplink signal through the reconfigurable delay detection network in an embodiment, the time phase delay of the received RF signal can be measured.

The metasurface hardware processor at the metasurface array in embodiments herein may execute machine readable code instructions of the metasurface hardware based geofencing system to determine the measured time phase delay of signal from the RDDN at the metasurface unit cells based on propagation across the known capacitance load in the RF transmission line of the RDDN. This measured time phase delay may then be compared to the expected time phase delay. The hardware-based measurement of resonance frequency may then be used to determine a hardware-based phase time delay for the incoming RF uplink signal may be taken at one or more of the plurality of metasurface unit cells.

If the measured time phase delay of the incoming RF signal determined using the RDDN does not match the expected time phase delay determined using the plural metasurface unit cells, this may indicate potential outside interference with the wireless link. In such a case, the metasurface hardware based geofencing system may notify the access point or other transmitter device of such a potential security breach and prompt potential mitigation efforts to address that breach. This notification may also include the measured time phase delay and its deviation from the expected time phase delay, which may be used to determine a true angle of departure of the uplink signal from the unauthorized user, and consequently to identify the physical location of the unauthorized device with respect to the metasurface array or the authorized access point in an embodiment.

A hardware processor at the access point in embodiments herein may then execute machine readable code instructions of a geofencing security enforcement system to perform remediation steps to investigate or neutralize the potential security breach. This may include terminating RF signals between the access point and the authorized endpoint information handling system, powering down the metasurface array, or physically locking down the geofence secured area, for example. In other examples, the access point may provide an information technology decision maker (ITDM) with an estimated location of the unauthorized device with respect to the metasurface array, based on the determined angle of departure of the uplink from the metasurface array to the unauthorized device. This may allow the ITDM to deploy security personnel to that location to disable any unauthorized devices. In such a way, the hardware processor of the metasurface array executing code instructions of the metasurface hardware based geofencing system may work in tandem with a reconfigurable delay detection network at plural metasurface unit cells of the metasurface array to determine and compare an estimated, expected time phase delay of an RF signal made based on a measured angle of arrival and a hardware-based measurement of a measured time phase delay for an RF uplink signal at a metasurface array to monitor and inhibit unauthorized devices from intercepting the RF uplink of a wireless link.

A metasurface hardware processor, such as a metasurface hardware controller, at the metasurface unit cell array in embodiments herein may also execute machine readable code instructions of a metasurface hardware based geofencing system to perform additional remediation steps at the metasurface unit cell array to neutralize the potential security breach. This may include the metasurface hardware processor executing code instructions of a metasurface hardware geofencing system to initially detect a capacitance state of the incoming RF signal from the RDDN to, based on an impendence and reflection coefficient look-up table, remap a delay configuration corresponding to a dynamic phase delay to be introduced into the reflected RF signal. As described herein, the incoming RF signal is received at a reflective pattern resonant structure of resonant structures from a plurality of metasurface unit cells within the metasurface unit cell array 170. This reflective pattern resonant structure is electromagnetically and operatively coupled to an RF signal probe in the SIW to measure the phase shifts between consecutive metasurface unit cells. A detected portion of the incoming RF signal electromagnetically coupled to the RF signal probe is transmitted to an RF transmission line of an RDDN with known capacitance load at fixed transmission line segments across the RDDN via a signal coupled readout pad at each SIW.

The metasurface hardware processor may detect this capacitance state of the incoming RF signal and determine how to readjust the impedance at each network of capacitors along the RDDN in order to concurrently adjust the phase of the RF signal while maintaining a quality of the RF signal such that RF signal loss is less than a maximum signal loss threshold. In an embodiment, the metasurface hardware processor may utilize data from, for example, a Smith chart that defines what levels of impedance can be imparted onto the RF signal at a particular frequency by the individual capacitor network or capacitor networks within the RDDN without losing quality or amplitude in the RF signal from impedance mismatch less than a maximum threshold signal loss level while still introducing a dynamically adjusted phase delay into the RF signal that is to be reflected off of the surface of the metasurface unit cell array. In an embodiment, the metasurface hardware controller may execute machine readable code instructions of an integrated AI-based anomaly detection algorithm with machine learning algorithms, such as a generative adversarial network (GAN) algorithm, to help define this dynamic phase delay and thereby derive those appropriate changes to the impedance imparted on the RF signal using the capacitor networks of the RDDN. Additionally, this remapping of the delay configuration of the RF signal allows the metasurface hardware controller to address each of the capacitors within the capacitor networks in the RDDN via RF pads of the RDDN dynamically over time in order to determine what capacitance to impart to generate a dynamic phase delay in the RF signal without causing substantial signal loss (e.g., the phase delay keeps the RF signal matched within a Smith chart). This is done prior to including this dynamic phase delay into the reflected RF signal via voltage adjustments being transmitted to the varactor placed on the reflective pattern resonant structure resonant structures of each of the metasurface unit cells of the metasurface unit cell array.

Thus, the metasurface hardware processor may further execute the machine readable code instructions of the metasurface hardware based geofencing system and an integrated AI-based anomaly detection algorithm to dynamically adjust the capacitance load configuration of the capacitor networks of the RDDN to determine the effect of remapping the delay configuration of the RF signals measured with the RDDN. This capacitive load configuration of the remapped delay configurations measured and set at the RDDN and is later used to generate the dynamic phase delay imparted by the tunable varactors at the reflective pattern resonant structures to the reflected RF signal to secure the communication between the transmitter device and the receiver device. The imparted inherent delay from the metasurface is shared between the transmitter and receiver devices in the radiofrequency environment. The imparted inherent phase delay makes interception of uplink or downlink wireless communication RF signal difficult or impossible for an eavesdropper in the radiofrequency environment.

This allows for the metasurface unit cell array to secure the communication between the transmitter device and the receiver device by full path integration correction using a hardware-based approach. The integration of the RDDN and a surface mounted diode (e.g., varactor diode) may be used to change the capacitance at the appropriate metasurface unit cells to dynamically alter the angle of departure (AoD) signal. In an embodiment, the dynamic phase delay may be imparted to each of the individual varactor diodes associated with each of the reflective pattern resonant structures of each metasurface unit cell such that the phase change is universal across the surface of the metasurface unit cell array. The beam directionality of the RF signal remains, but the beam phase includes the imparted dynamic phase delay in embodiments herein. By introducing this dynamic phase delay into the received RF signal and reflecting the RF signal (now including this imparted dynamic phase delay) to the receiving device, the metasurface unit cell array mitigates a change of path attack by continuously monitoring and dynamically changing the phase delay in the wireless transmission path while keeping the loss low and impedance as presentable on, for example, a Smith chart. Additionally, the computational footprint may be reduced through the use of artificial intelligence-based computations used to compute and phase delay in the AoD.

Thus, the metasurface hardware based geofencing system in embodiments herein may provide a robust, low-compute method for securing wireless communications through comprehensive full-path validation, especially in geofenced areas. Such geofenced areas may include, for instance, a corporate office, a research lab, or a government building that only allow authorized devices with metasurface technology to operate within the defined perimeter. In another example, such geofenced areas may include environments where events or temporary security needs arise, such as during a high-profile meeting or political conference. Finally, such geofenced areas may allow the metasurface hardware based geofencing system working in tandem with the geofencing security enforcement system to track the movement patterns of metasurface-equipped devices and generate alerts when a device enters a geofenced area unexpectedly or deviates from its usual movement patterns, such as when an unauthorized or authorized device follows another user or hovers near sensitive areas without prior authorization.

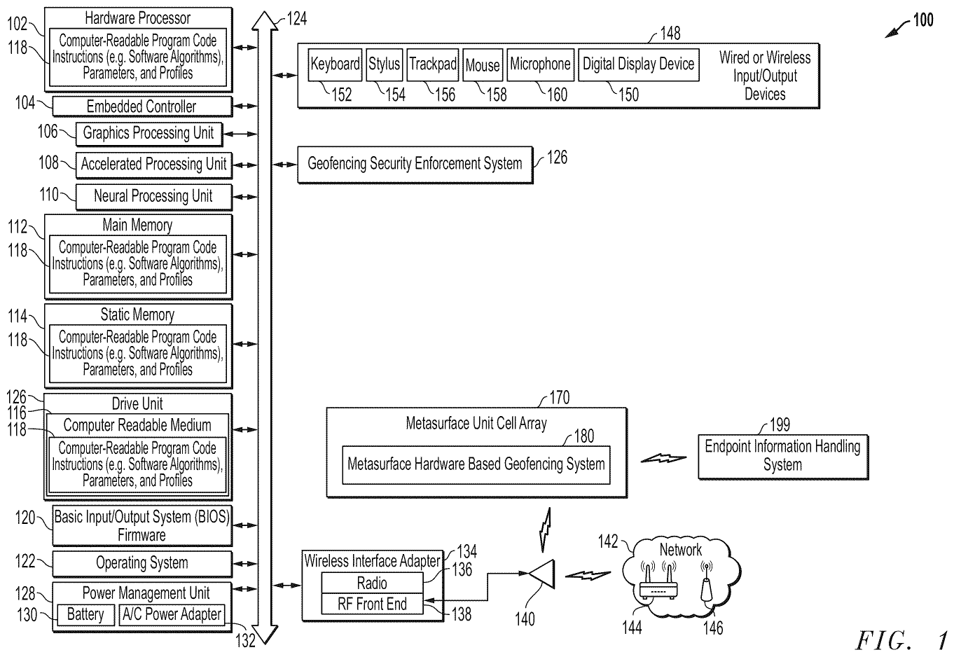

Turning now to the figures, FIG. 1 illustrates an information handling system 100 similar to the information handling systems according to several aspects of the present disclosure that may operate as a source or target radiofrequency device for use with the metasurfaces of the embodiments of the present disclosure. As described herein, a hardware processor 102 of the information handling system 100 may execute machine readable code instructions 118 of the geofencing security enforcement system 126 to locate unauthorized devices intercepting secured radiofrequency (RF) transmissions steered between an authorized access point (AP) and an authorized endpoint information handling system 199, via a metasurface array 150. The information handling system 100 in embodiments herein may include the authorized access point itself, or a control terminal for the authorized access point, for example.

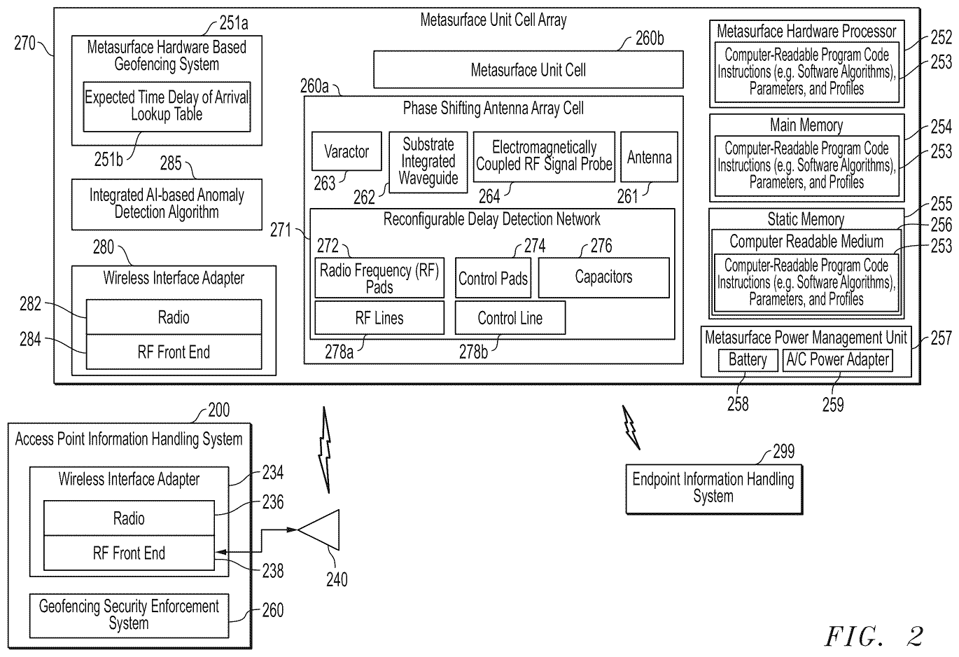

A metasurface hardware based geofencing system 180 of the metasurface array 150 in an embodiment may create a security framework that integrates hardware-based angle of arrival detection via a substrate integrated waveguide (SIW) with a signal probe embedded within one or more metasurface unit cells of the metasurface array 150 and hardware-based time phase delay detection via a reconfigurable delay detection network (RDDN) operably connected to one or more of such metasurface unit cells, as described in greater detail below with respect to FIG. 2. The metasurface hardware based geofencing system 180 may determine the angle of arrival of an RF signal incoming to the metasurface array 150 or a wireless link. Based on this determined angle of arrival, the metasurface hardware based geofencing system 180 may determine an estimated, expected time phase delay in the received RF signal for reflection of that incoming RF signal toward its intended target. If an unauthorized device attempts to scan the incoming RF signal and manipulate the authorized metasurface array 150 by steering the RF signal of the wireless link toward itself, this may cause an additional time phase delay in the RF signal that does not match the expected time phase delay from the angle of arrival of the AP.

The metasurface hardware based geofencing system 180 in an embodiment may then make a hardware-based determination of the measured time phase delay for the RF signal via a reconfigurable delay detection network (RDDN) in order to detect any such additional and unexpected time phase delay as well as determine any additional phase delay to be imparted in an uplink or downlink reflected RF signal as a security measure, as also described in greater detail below with respect to FIG. 2. This measured time phase delay may then be compared to the expected time phase delay. If the measured time phase delay of arrival determined using the RDDN does not match the expected time phase delay determined using the SIW and a probe across plural consecutive metasurface unit cells in the array 150, this may indicate potential outside interference with the wireless link at the metasurface array 150. In such a case, the metasurface hardware based geofencing system 180 may notify the access point 100 of such a potential security breach and the compromising of the RF signal and prompt potential mitigation efforts to address that breach. This notification may also include the deviation of the measured time phase delay from the expected time phase delay, which may be used to determine a true angle of departure of the uplink RF signal from the unauthorized user, and consequently to identify the physical direction or location of the unauthorized device with respect to the metasurface array 150 or the authorized transmitter in an embodiment. Further, the notification to the access point 100 or a target information handling system 100 within a radiofrequency environment may include any determined dynamic phase delay to be imparted into the reflected RF signals from the metasurface array 150 in embodiments herein.

The hardware processor 102 at the access point 100 in an embodiment may then execute machine readable code instructions 118 of a geofencing security enforcement system 126 to perform remediation steps to investigate or neutralize the potential security breach. This may include terminating RF signals between the access point 100 and the authorized endpoint information handling system 199, by disabling a transmitting antenna 140 at a transmitting information handling system 100, for example. In another example embodiment, this may include powering down the metasurface array 150, or physically locking down the geofence secured area, for example. In other examples, the access point 100 may provide an information technology decision maker (ITDM) with an estimated location of the unauthorized device with respect to the metasurface array 150, based on the determined angle of departure of the uplink from the metasurface array 150 to the unauthorized device. This may allow the ITDM to deploy security personnel to that location to disable any unauthorized devices. In such a way, the metasurface hardware based geofencing system 180 may work in tandem with the geofencing security enforcement system 126 to determine and compare an estimated time phase delay made based on a measured angle of arrival and a hardware-based measurement of measured time phase delay for an incoming RF uplink signal at a metasurface array 150 and to monitor and inhibit unauthorized devices from intercepting the RF uplink or a wireless link.

Although, in the embodiments herein, the geofencing security enforcement system 126 performs remediation steps to investigate or neutralize the potential security breach that may include terminating RF signals between the access point 100 and the authorized endpoint, other remediation steps may be undertaken to address the detection of a potential unauthorized device. In the embodiments herein, these additional remediation steps includes dynamically altering the delay in an angle-of-delay (AoD) signal reflected off of the surface of the metasurface unit cell array 170. Thus, although a metasurface hardware controller of the metasurface unit cell array 170 may report the detection of a potential unauthorized device, the metasurface controller may take further actions that still result in wireless communication continuity within the RF environment while still securing the wireless transmissions from the information handling system 100 and the authorized endpoint information handling system 199.

In a specific example, a metasurface hardware processor such as a metasurface hardware controller of the metasurface unit cell array may execute computer-readable program code instructions of a metasurface hardware based geofencing system 180 to extract a capacitance state of the metasurface unit cell from the RDDN to determine a delay configuration corresponding to the measured phase delay. This may include, in an embodiment, with the capacitance of each of the RDDNs of each unit cell of the metasurface unit cell array 170 being read by the metasurface hardware processor. The current bias voltage of the RDDN is read to infer an effective capacitance state. This allows the metasurface hardware processor operating each varactor at each unit cell to apply and monitor the reverse bias voltage across each varactor via the voltage control lines. By reading the applied voltage or sampling the voltage drop across each varactor, the metasurface hardware processor can infer the capacitance value currently set in the RDDN. Since the total phase delay introduced by the RDDN is a function of both the physical path geometry and the capacitance loading, this extracted capacitance state allows the metasurface hardware processor to determine the actual delay configuration active at the time the RF signal is received. This information may be used for accurately characterizing how the signal was processed at the metasurface unit cell and for preparing any necessary phase compensation to secure the wireless link.

As such, the metasurface hardware processor may use this extracted delay configuration and identified phase deviation to actively reconfigure the varactor-based delay network within the affected metasurface unit cells within the metasurface unit cell array 170. The metasurface hardware processor calculates a compensatory phase delay needed to realign the signal timing with the expected propagation profile, effectively mitigating the impact of any detected path manipulation or timing anomaly. To achieve this, the metasurface unit cell array 170 may output updated control voltages (e.g., via a digital-to-analog converters (DACs) or pulse-width modulated (PWM) analog driver) to the varactor diodes. These voltage adjustments change the capacitance at specific junctions within the transmission line segments, thereby modifying the effective propagation delay of the RF signal through the metasurface unit cells. The updated phase delay configuration is selected to both counteract the anomalous delay and maintain low-loss impedance matching, ensuring continued signal integrity and minimal disruption to the wireless link. This may be done through cooperating metasurface unit cells that are assigned delay adjustments in relation to their position within the metasurface unit cell array 170 and the detected AoA and an AoA from the wireless link. This results in a spatially varying phase profile engineered to reflect the RF wavefront in a desired direction (e.g., specular reflection, beamsteering, beamforming, etc.). Each metasurface unit cell thus acts as a tunable phase-shifting element, and together, they form a programmable reflective surface capable of compensating for signal disruptions and dynamically shaping the RF beam in response to real-time environmental conditions and attack mitigation requirements.

In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system within a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be accessible by hardware processing resources using that main memory 112. Computer-readable program code instructions stored in static memory 114, main memory 112, or drive unit 126 may be involved in invoking such computer-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various wired or wireless input and output (I/O) devices 148, such as a mouse, a trackpad, a stylus, a keyboard, a digital display device, a microphone, or any combination thereof. Portions of an information handling system 100 may themselves be considered information handling systems 100.

Information handling system 100 may include devices or modules that embody one or more of the devices or execute instructions for one or more systems and modules. The information handling system 100 may execute computer-readable program code instructions (e.g., software algorithms) parameters, and profiles 118 that may operate on servers or systems, remote data centers, or on-box in individual client information handling systems according to various embodiments herein. In some embodiments, it is understood any or all portions of computer-readable program code instructions (e.g., software algorithms) parameters, and profiles 118 may operate on a plurality of information handling systems 100.

The information handling system 100 may include the hardware processor 102 such as a central processing unit (CPU) or other hardware processing resource (e.g., 104, 106, 108, 110). Any of the hardware processing resources may operate to execute computer readable code instructions that are either firmware or software code, such as those software systems and modules described herein. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing computer-readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a mouse, a trackpad, a stylus, a keyboard, a digital display device, a microphone, among other peripheral devices.

As described herein, the information handling system 100 further includes a the wired or wireless I/O device 148 such as a digital display device which may function as a liquid crystal display (LCD), an organic light emitting diode (OLED), a flat panel display, or a solid-state display. It is appreciated that the digital display device may be wired or wireless and may be an external digital display device that allows a user to increase the desktop area by extending the desktop in an embodiment. Information handling system 100 may also be operatively coupled to a wired or wireless input/output device 148 or other hardware devices that may include a cursor control device (e.g., a trackpad), or gesture or touch screen input), a stylus, and/or a keyboard, among others that allows the user to interface with the information handling system 100 via the digital display device, or a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among plural devices such as with Bluetooth® or to a network 142 such as with a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among any wireless peripheral device to be paired or paired with the information handling system 100 or other information handling systems.

In other embodiments, the wireless interface device 134 with its radio 136, RF front end 138 and antenna 140 is used to communicate with a WWAN or and WLAN which may each include an AP 144 or base station 146 used to operatively couple the information handling system 100 to a network 142 via the wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more radiofrequency (RF) subsystems (e.g., radio 136) with transmitter/receiver circuitry, modem circuitry, one or more antenna RF (RF) front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols. It is appreciated that the information handling system 100 may wirelessly communicate with an authorized endpoint information handling system 199 via the metasurface array 150. The authorized endpoint information handling system 199 may be any other device and may include the AP 144, the base station 146, or any other computing device described herein. Additionally, the information handling system 100 and authorized endpoint information handling system 199 may be capable of transmitting wireless data using, for example, EM waves that include 5G mm wave lengths such as those included within the 20-50 GHz range or WiFi wavelengths such as 2.4 GHz, 5 GHz, 6 GHz, or others to be used with later versions of WiFi. Thus, in an embodiment, the metasurface array 150 is capable of relaying these types of mm waves.

In an embodiment, the wireless interface adapter 134 may operate in accordance with any wireless data communication standards. To communicate with a wireless local area network and/or the receiver device 178, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit (ASIC). Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 118 or receives and executes computer-readable program code instructions, parameters, and profiles 118 responsive to a propagated signal, so that a hardware device connected to a network 142 may communicate voice, video, or data over the network 142. Further, the computer-readable program code instructions, parameters, and profiles 118 may be transmitted or received over the network 142 via the network interface device or wireless interface adapter 134.

The information handling system 100 may include a set of computer-readable program code instructions, parameters, and profiles 118 that may be executed to cause the computer system to perform any one or more of the methods or computer-based functions disclosed herein. For example, computer-readable program code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application computer-readable program code instructions, parameters, and profiles 118 may be coordinated by an operating system (OS) 122, and/or via an application programming interface (API) include a unified device API described herein. An example OS 122 may include Windows®, Android®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, the video/graphic display device, or other wired or wireless I/O devices 148 and other components that may require power when a power button has been actuated by a user. In an embodiment, the PMU 128 may monitor power levels and be electrically coupled to the information handling system 100 in embodiments herein to provide this power. The PMU 128 may be coupled to the bus 124 to provide or receive data or machine-readable code instructions. The PMU 128 may regulate power from a power source such as the battery 130, or AC power adapter 132. In an embodiment, the battery 130 may be charged via the AC power adapter 132 and provide power to the components of the information handling system 100, via wired connections, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

FIG. 2 is a block diagram illustrating a metasurface array steering a wireless radio frequency (RF) transmission between a secure access point and an authorized endpoint information handling system while executing code instructions of a metasurface hardware based geofencing system to ensure that the steered RF signal is not intercepted by an unauthorized device according to an embodiment of the present disclosure. As described herein, With the advent of massive multiple input multiple output (MIMO) wireless technologies, a group of antennas at both the transmitting device, such as a wireless access point 200 and receiving device, such as an authorized endpoint information handling system 299 may provide high spectral and energy efficient wireless communication systems. In an embodiment of the present disclosure, a thin metasurface unit cell array 270 can be installed on building surfaces or other surfaces within a geofence secured radiofrequency environment that may be used to steer these EM waves and expand wireless range or signal quality. This metasurface unit cell array 270 may include metasurface unit cells such as 260a in arrays in embodiments herein. The metasurface arrays 250 of embodiments of the present disclosure may be used within current infrastructures having radiofrequency environments within, for example, office settings or home settings where radiofrequency data communication could benefit from these metasurface arrays 250 relaying EM wave transmissions around corners, into various office spaces, and/or into various rooms. In other words, a metasurface unit cell array 270 placed in a known location and at a known angle with respect to both a fixed-location access point 200 and a fixed-location authorized endpoint information handling system 299 may reflect RF signals of a wireless link received from one of these fixed locations directly to the other, even when an interference causing barrier (e.g., wall) is located in the direct path between those fixed locations. In other aspects of an embodiment, the metasurface arrays 250 may be used to steer RF signals of a wireless link received from one of these fixed locations directly to the other even in the absence of such an obstruction as a means of securing the directionality of the transmission between two secured or authorized devices 200 and 299.

The wireless interface adapter 280 of the metasurface unit cell array 270 in an embodiment may establish wireless links with antenna 261 to an access point information handling system 200 and with an authorized endpoint information handling system 299 to communicate security information when compromised integrity of RF signals are detected. In an embodiment, the metasurface unit cell array 270 may be used to communicate with the information handling system 200 and the authorized endpoint information handling system 299, via, for example, a wide area network (WAN), a local area network (LAN), wireless local area network (WLAN), a wireless personal area network (WPAN), a wireless wide area network (WWAN), or other network. In embodiments described herein, the wireless interface device 280 with its radio 282, RF front end 284 and antenna 261 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among any wireless peripheral device to be paired or paired with the metasurface array 150 or other information handling systems.

In other embodiments, the wireless interface device 280 with its radio 282, RF front end 284 and antenna 261 is used to communicate with a WWAN or/and WLAN which may each include an AP 200 or base station used to operatively couple the metasurface unit cell array 270 to a network via the wireless interface adapter 280. In a specific embodiment, the network may include macro-cellular connections via one or more base stations or a wireless AP 200 (e.g., Wi-Fi), or such as through licensed or unlicensed WWAN small cell base stations. Connectivity may be via wired or wireless connection. For example, wireless network wireless APs 200 or base stations may be operatively connected to the metasurface unit cell array 270. Wireless interface adapter 280 may include one or more RF (RF) subsystems (e.g., radio 282) with transmitter/receiver circuitry, modem circuitry, one or more antenna RF (RF) front end 284 circuits, one or more wireless controller circuits, amplifiers, antennas 261 and other circuitry of the radio 282 such as one or more antenna ports used for wireless communications via multiple radio access technologies (RATs). The radio 282 may communicate with one or more wireless technology protocols.

It is appreciated that the AP information handling system 200 may wirelessly communicate with an authorized endpoint information handling system 299 via a secure wireless link reflected by the metasurface unit cell array 270. The authorized endpoint information handling system 299 may be any other device and may include another AP, or a base station, or any other computing device described herein. Additionally, the information handling system 200 and authorized endpoint information handling system 299 may be capable of transmitting wireless data using, for example, EM waves that include 5G mm wave lengths such as those included within the 20-50 GHz range or WiFi wavelengths such as 2.4 GHz, 5 GHz, 6 GHz or others to be used with later versions of WiFi on a WiFi wireless link. Thus, in an embodiment, the metasurface unit cell array 270 is capable of relaying these types of mm waves.

The metasurface unit cell array 270 may include a metasurface hardware processor 252, which may include a central processing unit (CPU), embedded controller (EC), a metasurface hardware controller or a hardware microcontroller unit (MCU), other types of hardware processing devices, or any combination thereof. Moreover, the metasurface unit cell array 270 may include main memory 254, or static memory 255 such as volatile (e.g., random-access memory, etc.), nonvolatile memory (read-only memory, flash memory etc.) or any combination thereof or other memory with computer readable medium storing machine readable code instructions (e.g., software or firmware algorithms), parameters, and profiles 253 executable by the hardware processor 252, respectively or any other hardware processing device to perform the processes described herein. Memory 254 or static memory 255 or other memory of the embodiments described herein may contain computer-readable medium 256, respectively, such as RAM in an example embodiment. In an embodiment, main memory 254 or static memory 255 may contain computer-readable medium 256, such as NOR or NAND flash memory in some example embodiments. Another example of main memory 254 or static memory 255 includes random access memory (RAM) such as static RAM (SRAM), dynamic RAM (DRAM), non-volatile RAM (NV-RAM), or the like, as well as read only memory (ROM), another type of memory, or a combination thereof in other embodiments herein.

In an embodiment, the metasurface unit cell array 270 may further include a power management unit (PMU) 257 (a.k.a. a power supply unit (PSU)). The PMU 257 may include a hardware controller and executable machine-readable code instructions to monitor and manage the power provided to the components of the metasurface unit cell array 270, the hardware processor 252 and other hardware components of a RDDN 271 described herein. The PMU 257 may control power to one or more components including the static memory 255, the hardware processor 252, antenna 261, or other hardware components of a RDDN 271 that may require power when a power button has been actuated by a user. In an embodiment, the PMU 257 may monitor power levels and be electrically coupled to the metasurface unit cell array 270 to provide this power. The PMU 257 may regulate power from a power source such as the battery 258, or AC power adapter 259. In an embodiment, the battery 258 may be charged via the AC power adapter 259 and provide power to the components of the metasurface unit cell array 270, via wired connections as applicable, or when AC power from the AC power adapter 259 is removed.

As metasurfaces 250 become integral to wireless communication systems, they introduce both benefits and security risks. Traditional systems rely on encryption and secure protocols to protect data, but these measures often focus on securing the content rather than the transmission path. Unauthorized devices can exploit physical vulnerabilities, such as intercepting signals through authorized nearby devices or placing rogue access points, to gain unauthorized access to the RF signals within the geofenced area. This risk is exacerbated in environments with high-density networks or public access points, where monitoring and controlling all possible points of interception becomes impractical. In some cases of high-security areas, individuals may be issued badges with metasurfaces, or such devices may be attached to their laptops. It is possible for an unauthorized device or its metasurface array to intercept a radio frequency (RF) uplink signal between the access point (AP) 200 and the authorized metasurface 250, or an RF downlink signal between the authorized metasurface 250 and the authorized endpoint information handling system 299. The metasurface hardware based geofencing system 251a in an embodiment may ensure that unauthorized individuals or devices, or their metasurface can go only within allowed perimeters and flag any unauthorized device or its metasurface in an unauthorized area as a potential security risk.

The metasurface hardware based geofencing system 251a in an embodiment may create a security framework that integrates hardware-based angle of arrival detection via a substrate integrated waveguide (SIW) 262 forming an interior chamber containing an electromagnetically coupled RF signal probe 264 embedded within one or more metasurface unit cells 260a of the metasurface unit cell array 270. The metasurface hardware based geofencing system 251a also includes a hardware-based time phase delay detection via a reconfigurable delay detection network (RDDN) 271 operably connected to one or more of such metasurface unit cells 260a or 260b in embodiments herein. The SIWs 262 in an embodiment may include an electromagnetically coupled RF signal probe 264 to couple a small portion of the incoming RF signal (e.g., either an uplink or downlink signal) to measure the phase shifts between consecutive metasurface unit cells 260a and 260b. By analyzing these phase shifts using the expected time delay of arrival lookup table 251b, the hardware processor 252 of the metasurface unit cell array 270 executing code instructions of the metasurface hardware based geofencing system 251a may determine the angle of arrival of the incoming RF signal from a secure access point 200. Based on this determined angle of arrival, the hardware processor 252 of the metasurface unit cell array 270 executing code instructions of the metasurface hardware based geofencing system 251a may determine an estimated, expected time phase delay for that incoming RF signal being reflected toward its intended target (e.g., 200 or 299) by the metasurface unit cell array 270. If an unauthorized device attempts to intercept the RF signal and pass it along to the intended target (e.g., the authorized endpoint information handling system 299 or from a secure access point 200), this may cause an additional time phase delay in the RF signal that does not match the expected time phase delay.

The hardware processor of the metasurface unit cell array 270 executing code instructions of the metasurface hardware based geofencing system 251a in an embodiment may then make a hardware-based measurement of the measured time phase delay for the RF signal in order to detect any such additional and unexpected time phase delay. For example, the incoming RF uplink signal in an embodiment may be fed down a reconfigurable delay detection network (RDDN) 270 with known capacitance load on an RF transmission line at resonance frequency measuring capacitors 276 located at fixed transmission line segments across the RDDN 270. Capacitors 276 within the RDDN 270 may be loaded to known capacitance values in order to generate impedance at each junction of capacitors within the RF lines 278a when the incoming RF uplink signal is fed from one RF pad 272 (e.g., to the right of the reconfigurable delay detection network) to another RF pad (e.g., to the left of the reconfigurable delay detection network). Upon feeding the incoming RF uplink signal through the RDDN 271 in an embodiment, the control line 278b of the RDDN 271 may be compared to the RF lines 278a to measure the resonance frequency generated by the known capacitance values at the capacitor 276 junctions to determine a measured time phase delay of the RF signal.

The hardware processor 252 at the metasurface unit cell array 270 in an embodiment may execute machine readable code instructions 253of the metasurface hardware based geofencing system 251a to determine the measured time phase delay of the RF signal from outputs of the RDDN 270 at the metasurface unit cells 260a or 260b. This measured time phase delay may then be compared to the expected time phase delay. The hardware-based measurement of measured phase time delay for the incoming RF uplink signal may be measured from one or more of the plurality of metasurface unit cells 260a or 260b.

If the measured time phase delay of the incoming RF signal determined using the RDDN 270 deviates from the expected time phase delay determined using the electromagnetically coupled RF signal probe 264 of the SIW 262, this may indicate potential outside interference with the wireless link. In such a case, the metasurface hardware based geofencing system 251a may notify the access point 200 of such a potential security breach via the wireless interface adapter 280 and prompt potential mitigation efforts to address that breach. This notification may also include the measured time phase delay and deviation from the expected time phase delay of the RF signal, which may be used to determine a true angle of departure of the uplink RF signal toward the unauthorized user, and consequently to identify the physical direction or location of the unauthorized device with respect to the metasurface unit cell array 270 and transmitter AP information handling system 200 in an embodiment.

A hardware processor 202 at the access point 200 in an embodiment may receive this notification via antenna 240 and wireless interface adapter 234, then execute machine readable code instructions of a geofencing security enforcement system 227 to perform remediation steps to investigate or neutralize the potential security breach. This may include terminating RF signals between the access point 200 and the authorized endpoint information handling system 299, powering down the metasurface unit cell array 270, or physically locking down the geofence secured area, for example. In other examples, the access point 200 may provide an information technology decision maker (ITDM) with an estimated location of the unauthorized device with respect to the metasurface unit cell array 270, based on the determined angle of departure of the uplink from the metasurface unit cell array 270 to the unauthorized device. This may allow the ITDM to deploy security personnel to that location to disable any unauthorized devices. In such a way, the hardware processor 252 of the metasurface unit cell array 270 executing code instructions of the metasurface hardware based geofencing system 251a may work in tandem with a reconfigurable delay detection network 277 of at least one metasurface unit cell 260a or 260b of the metasurface unit cell array 270 to determine and compare an estimated time phase delay made based on a measured angle of arrival and a hardware-based measurement of measured time phase delay for an RF uplink signal at a metasurface unit cell array 270 to monitor and inhibit unauthorized devices from intercepting the RF uplink of a wireless link between the metasurface array 260 and the authorized endpoint information handling system 299.

As described above, in addition to the metasurface hardware based geofencing system 251a notifying the access point 200 of the potential security breach and prompting potential mitigation efforts to address that breach, the metasurface hardware based geofencing system 251a may also engage in other remediation steps to address the detection of a potential unauthorized device. In the embodiments herein, these additional remediation steps includes dynamically altering the delay in an angle-of-delay (AoD) signal reflected off of the surface of the metasurface unit cell array 270. This may be done, in an example embodiment, by characterizing the incoming signal by reading its capacitance signature. In an embodiment, the RDDN is used to initially detect a capacitance state of the incoming RF signal from the RDDN to, based on an impendence and reflection coefficient look-up table, remap a delay configuration corresponding to a dynamic phase delay to be introduced into the reflected RF signal. As described herein, the incoming RF signal is received at a reflective pattern resonant structure of a plurality of metasurface unit cells within the metasurface unit cell array 270. This reflective pattern resonant structure is operatively coupled to the SIW 262 that includes an electromagnetically coupled RF signal probe 264 that measures the incoming RF signals to the metasurface array 270 and the phase shifts between consecutive metasurface unit cells 260a, 260b. The RF signal probe 264 electromagnetically couples a small portion of the incoming RF signal and transmits that small portion of the incoming RF signal, via a signal coupled readout pad at each SIW 262, to an RF transmission line 278a of an RDDN 271 with known capacitance load at fixed transmission line segments across the RDDN 271.

The metasurface hardware processor 252 may detect this capacitance state of the incoming RF signal and determine how to readjust the known capacitance load for the impedance at each network of capacitors 276, having switchable capacitors, in order to concurrently adjust a phase delay measured for the captured RF signal while maintaining a quality of the RF signal such that RF signal loss is less than a maximum signal loss threshold. Loss may occur differently among various frequencies of RF signals based on impedance from capacitance load imparted to the captured RF signal. In an embodiment, the metasurface hardware processor 252 may utilize data from, for example, a Smith chart that determines what levels of impedance can be imparted onto the captured RF signal within the RDDN 271 by the individual capacitor networks without losing quality in the RF signal while still introducing a dynamic phase delay into the captured RF signal measured by the RDDN 271. This dynamic phase delay is to be imparted in the RF signal that is to be reflected off of the surface of the metasurface unit cell array 270. In an embodiment, the metasurface hardware controller 252 may execute machine readable code instructions of an integrated AI-based anomaly detection algorithm 285 to help define this dynamic phase delay thereby utilizing machine learning techniques (e.g., artificial intelligence techniques) to derive those appropriate changes to the impedance imparted on the captured RF signal by the capacitors 276 of the capacitor networks of the RDDN 271.

Additionally, this remapping of the delay configuration of the captured RF signal allows the metasurface hardware controller 252 to address each of the capacitors 276, individually, within the capacitor networks in the RDDN 271 in order to determine this dynamic phase delay into the captured RF signal, via an output RF pads 272 of the RDDN 271, prior to imparting that dynamic phase delay to the reflected RF signal at the surface of the metasurface unit cell array 270. The metasurface hardware controller 252 may then determine the capacitive load to be used for the imparted dynamic phase delay and transmit voltage adjustment to the tunable varactor 263 placed on the reflective pattern resonant structure or antenna 261 of each of the metasurface unit cells 260a, 260b of the metasurface unit cell array 270 to adjust surface impedance and impart the determined dynamic phase delay into the reflected RF signal. This phase delay is also shared wirelessly, out of band or encrypted in-band, with the access point information handling system 200 and endpoint information handling system 299, but not an eavesdropping device, in the radiofrequency environment.

Thus, the metasurface hardware processor 252 may further the machine readable code instructions of the metasurface hardware based geofencing system to dynamically adjust the capacitance load configuration with a dynamically remapped delay configuration of the capacitors 276 of the capacitor networks of the RDDN 271 to determine the dynamic phase delay to be imparted based on the capacitance load configuration at the RDDN 271 in embodiments herein. This capacitance load configuration may then be determined to not impart signal loss of the RF signal more than a threshold RF signal loss amount and the capacitance load may be applied for the dynamic phase delay to the reflected RF signal via the tunable varactor 263 at the metasurface unit cells 260b to secure the communication between the transmitter device (e.g., the access point information handling system 200) and the receiver device (e.g., the endpoint information handling system 299). This allows for the metasurface unit cell array 270 to secure the communication between the transmitter device (e.g., 200) and the receiver or target device (e.g., 299) by full path integration correction and imparted dynamic phase delay using a hardware-based approach. The integration of the RDDN 271 and a surface mounted diode (e.g., tunable varactor diode 263) may be used to change the capacitance at the appropriate metasurface unit cells 260a, 260b to dynamically alter the angle of departure (AoD) signal and impart an determined dynamic phase delay to the reflected RF signal having limited signal loss.

In an embodiment, the dynamic phase delay may be imparted to each of the individual varactor diodes 263 associated with each of the antenna 261 of each metasurface unit cells 260a, 260b such that the phase change is universal across the surface of the metasurface unit cell array 270, but does not affect beam directionality of the reflected RF signal. By introducing this dynamic phase delay into the received RF signal and reflecting the RF signal (now including this dynamic phase delay) to the receiving device 299, the metasurface unit cell array 270 mitigates a change of path attack by continuously monitoring and dynamically changing the phase delay in the wireless transmission path while keeping the loss low and impedance as presentable on, for example, a Smith chart. The imparted dynamic phase delay is shared with the transmitting device 200 and receiving device 299 in the radiofrequency environment. Additionally, the computational footprint may be reduced through the use of artificial intelligence-based computations used to compute and impart the phase delay in the AoD.

Following this real-time signal correction, the execution of the metasurface hardware based geofencing system 251a by the metasurface hardware controller 252 causes the metasurface hardware controller 252 to engage in a continuous anomaly detection pipeline and dynamic phase delay introduction. Signal characteristics such as amplitude, signal-to-interference-plus-noise ratio (SINR), and phase coherence are continuously fed into a local dataset managed by the hardware metasurface controller 252. In an embodiment, the integrated AI-based anomaly detection algorithm 285 may execute as machine readable code instructions of machine learning algorithms such as a generative adversarial network (GAN), a deep reconfigurable learning (DRL) algorithm, a large language model (LLM) algorithm, or a convolutional neural network (CNN) algorithm may be used to processes this data in order to identify new or evolving threats and adjust the dynamic phase delay in transmissions. This reduces vulnerability to sophisticated interception techniques at the metasurface unit cell array 270 while minimizing the computational footprint of conventional monitoring systems.

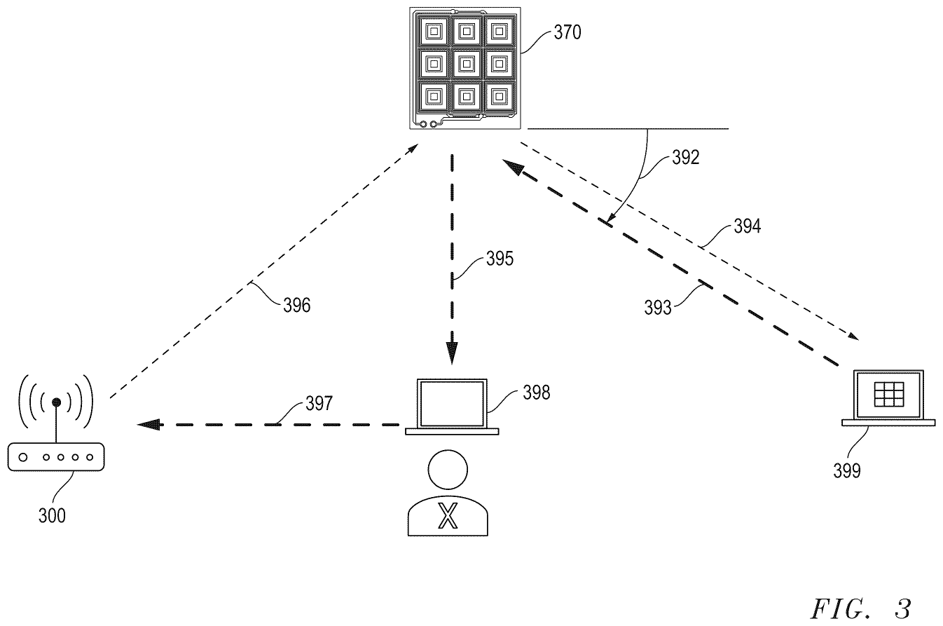

FIG. 3 is graphical diagram illustrating a metasurface array steering a wireless radio frequency (RF) transmission of a wireless link between a secure access point and an authorized endpoint information handling system while executing code instructions of a metasurface hardware based geofencing system to ensure that the steered RF signal is not intercepted by an unauthorized device according to an embodiment of the present disclosure. As described herein, a series of thin surfaces or panels can be installed on building surfaces or other surfaces within a geofence secured radiofrequency environment that may be used to steer EM waves and expand wireless range or signal quality. Some of these surfaces may include metasurface unit cells in arrays referred to as metasurface unit cell array 370 in embodiments herein. The metasurface unit cell array 370 of embodiments of the present disclosure may be used within current infrastructures having radiofrequency environments within, for example, office settings or home settings where radiofrequency data communication could benefit from these metasurfaces 350 relaying EM wave transmissions around corners, into various office spaces, and/or into various rooms. In other words, a metasurface unit cell array 370 placed in a known location and at a known angle with respect to both a fixed-location access point 300 and a fixed-location authorized endpoint information handling system 399 to reflect RF signals 396 and 394 of a wireless link received from one of these fixed locations directly to the other, even when an interference causing barrier (e.g., wall) is located in the direct path between those fixed locations 300 and 399.

In other aspects of an embodiment, the metasurface unit cell array 370 may be used to steer RF signals 396 and 394 of a wireless link received from one of these fixed locations 300 or 399 directly to the other, even in the absence of an obstruction, as a means of securing the directionality of the RF signal transmission 396 and 394 between two secured or authorized devices 300 and 399. More specifically, the metasurface unit cell array 370 in an embodiment may steer a received downlink RF signal 396 from the AP 300 directly to the authorized endpoint information handling system 399 via downlink RF signal 394. In addition, the metasurface unit cell array 370 may steer a received uplink RF signal 393 from the authorized endpoint information handling system 399 to the AP 300. However, it is possible for an unauthorized device 398 to tamper with metasurface unit cell array 370 to intercept RF signal 393 and divert the uplink signal 395 through the unauthorized device 398, which will then steer the diverted uplink signal 395 back to the AP 300 via link 397, rather than allowing the metasurface unit cell array 370 to transmit the uplink signal directly to the AP 300 from the authorized endpoint information handling system 399.

The metasurface hardware based geofencing system of the metasurface unit cell array 370 in an embodiment may address this issue by creating a security framework that integrates hardware-based angle of arrival detection via an electromagnetically coupled RF signal probe within a SIW embedded within plural, consecutive metasurface unit cells of the metasurface unit cell array 370 and hardware-based time phase delay detection via a reconfigurable delay detection network operably connected to one or more of such metasurface unit cells in the metasurface unit cell array 370. In an embodiment, these hardware-based security measures are not reliant solely on encryption and ensure that even if an unauthorized person 398 gains physical proximity to the signal path, the metasurface unit cell array 370 can detect and neutralize their efforts to intercept or manipulate the RF signal wireless link 395, offering a significant security advantage over conventional direct connection methods.

The electromagnetically coupled RF signal probes in the SIWs of the metasurface unit cell array 370 in an embodiment may couple a small portion of the incoming RF signal 393 to measure the phase shifts between consecutive metasurface unit cells of the metasurface unit cell array 370. In other embodiments, the incoming RF signal may be the downlink signal 396 from the AP 300, which may be intercepted between the metasurface 350 and the authorized endpoint information handling system 399 by the unauthorized device 398. By analyzing these phase shifts, the metasurface unit cell array 370 executing code instructions of the metasurface hardware based geofencing system may determine the angle of arrival 392 of the incoming RF signal 393 (e.g., either from the authorized endpoint information handling system 399 or from a secure access point 300). Based on this determined angle of arrival 392, the metasurface unit cell array 370 executing code instructions of the metasurface hardware based geofencing system may determine an estimated, expected time phase delay for reflection of that incoming RF signal 393 toward its intended target 300. If an unauthorized device 398 attempts to manipulate the authorized metasurface 350 to steer the RF signal 395 toward itself, rather than the intended target 300 before passing the RF signal 397 to target AP 300, this may cause an additional time phase delay in the reflection that does not match the expected time phase delay.

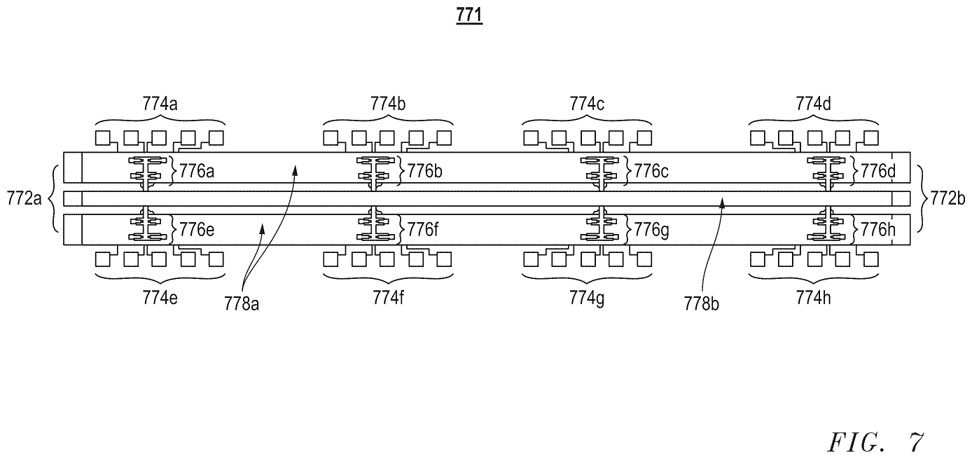

The metasurface unit cell array 370 executing code instructions of the metasurface hardware based geofencing system may then make a hardware-based determination of the measured time phase delay for the RF signal 395 in order to detect any such additional an unexpected time phase delay, as described in greater detail with respect to FIG. 7. This measured time phase delay may then be compared to the expected time phase delay for the incoming RF uplink signal 393 at one or more of the plurality of metasurface unit cells of the metasurface unit cell array 370. If the measured time phase delay of the RF signal deviates and does not match the expected time phase delay, this may indicate potential outside interference by the unauthorized device 398 with the wireless link reflected via the metasurface unit cell array 370. In such a case, the metasurface hardware based geofencing system at the metasurface 350 may notify the access point 300 of such a potential security breach and prompt potential mitigation efforts to address that breach. This notification may also include the measured time phase delay or deviation from the expected time phase delay of the RF signal, which may be used to determine a true angle of departure 391 of the uplink signal 395 toward the unauthorized user 398, and consequently to identify the physical direction or location of the unauthorized device 398 with respect to the metasurface unit cell array 370 in an embodiment.

A hardware processor at the access point 300 in an embodiment may then execute machine readable code instructions of a geofencing security enforcement system to perform remediation steps to investigate or neutralize the potential security breach. This may include terminating RF signals between the access point 300 and the authorized endpoint information handling system 399, powering down the metasurface unit cell array 370, or physically locking down the geofence secured area, for example. In other examples, the access point may provide an information technology decision maker (ITDM) with an estimated location of the unauthorized device 398 with respect to the metasurface unit cell array 370, based on the determined angle of departure 391 of the uplink from the metasurface unit cell array 370 to the unauthorized device 398. This may allow the ITDM to deploy security personnel to that location to disable any unauthorized devices 398. In such a way, the hardware processor of the metasurface unit cell array 370 executing code instructions of the metasurface hardware based geofencing system may work in tandem with plural unit cells and a reconfigurable delay detection network of at least one metasurface unit cell of the metasurface unit cell array 370 to determine and compare an estimated, expected time phase delay made based on a measured angle of arrival 392 and a hardware-based measurement of measured time phase delay for an RF uplink signal at a metasurface unit cell array 370 to monitor and inhibit unauthorized devices 398 from intercepting the RF uplink of a wireless link.

Again, in addition to the metasurface hardware based geofencing system notifying the access point 300 of the potential security breach and prompting potential mitigation efforts to address that breach, the metasurface hardware based geofencing system may also engage in other remediation steps to address the detection of a potential unauthorized device. In the embodiments herein, these additional remediation steps includes dynamically altering the phase delay in an AoD of the reflected RF signal reflected off of the surface of the metasurface unit cell array 370. This may be done, in an example embodiment, by characterizing the incoming signal by reading its capacitance signature at an RDDN. In an embodiment, the RDDN is used to detect a capacitance state of the incoming RF signal from the RDDN to, based on an impendence and reflection coefficient look-up table, remap a delay configuration corresponding to a dynamic phase delay to be introduced into the reflected RF signal.

The RDDN may selectively alter the imparted phase delay of the RF signal by dynamically adjusting, based on the remapped delay configuration and the capacitance load configuration determined via the RDDN to apply the dynamic phase delay via tunable varactors to the reflected RF signal at the surface of metasurface unit cells to secure the communication between the transmitter device such as AP 300 and the receiver device information handling system 399. The imparted dynamic phase delay of the reflected RF signal may be controlled by dynamically adjusting the surface impedance with circuit capacitance adjustment using an SMD varactor diode integrated with the surface resonant structures of the metasurface unit cells or within a tunable phase delay circuit operatively coupled to a set of metasurface unit cells via an RF circuit in various embodiments. This element-level phase shifting allows the beam to maintain its intended direction while subtly altering its propagation characteristics in time as a security measure not shared with eavesdropping information handling system 398. The correction mechanism ensures the remapped signal maintains impedance compatibility as verified using, for example, a Smith Chart analysis, thereby avoiding signal loss due to impedance mismatches. This technique renders the communication path unpredictable and unintelligible to the unauthorized intercepting device, effectively preventing uplink and downlink interception.

Following this real-time signal correction, the execution of the metasurface hardware based geofencing system by the metasurface hardware processor causes the metasurface hardware processor to engage in a continuous anomaly detection pipeline. Signal characteristics such as amplitude, SINR, and phase coherence are continuously fed into a local dataset managed by the hardware metasurface controller. In an embodiment, an integrated AI-based anomaly detection algorithm such as a CNN algorithm may be used to processes this data in order to identify new or evolving threats. This reduces vulnerability to sophisticated interception techniques at the metasurface unit cell array 370 while minimizing the computational footprint of conventional monitoring systems.

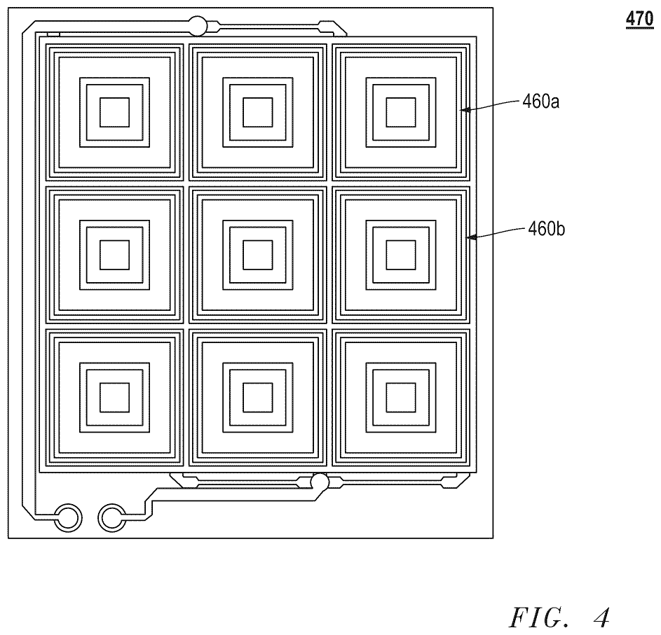

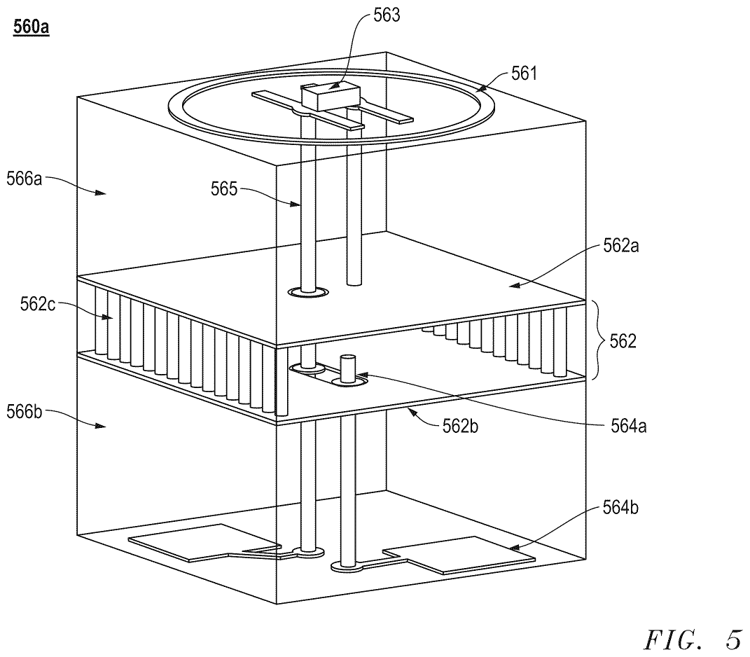

FIG. 4 is graphical diagram illustrating a metasurface array of a plurality of metasurface unit cells for steering an incoming RF signal between a secure access point and an authorized endpoint information handling system according to an embodiment of the present disclosure. A metasurface unit cell array 470 in an embodiment may include a plurality of metasurface unit cells, such as 460a and 460b, for example. Each of these adjacent, consecutive metasurface unit cells 463a and 463b may incorporate signal coupled readout pads for determining an angle of arrival for an incoming RF signal and measuring a time phase delay for the reflected transmission, as described in greater detail below with respect to FIGS. 5 and 7. It is contemplated that the metasurface unit cell array 470 may be any sized array of metasurface unit cells 460a and 460b in various embodiments herein.

FIG. 5 is graphical diagram illustrating a perspective view of a metasurface unit cell incorporating a substrate integrated waveguide 562 housing an electromagnetically coupled RF signal probe 564a for detecting an angle of arrival for incoming RF transmissions for determination of an estimated time phase delay to determine anomalies and for determination of a dynamic phase delay to be imparted into the RF signal according to an embodiment of the present disclosure. A metasurface unit cell array in an embodiment may include a plurality of metasurface unit cells, such as 560a, which may each include a reflective pattern resonant structure 561 of conductive material acting as a steering antenna for the reflection of the incoming RF signal in a pre-determined direction, such as from an authorized transmitter device (e.g., an authorized endpoint information handling system) to an authorized receiver device (e.g., a secure access point). The varactor diode 563 may tune the reflected RF signal of reflective pattern resonant structure 561 in an embodiment after, in the embodiments herein, the metasurface hardware processor executes code instructions of a metasurface hardware geofencing system to compare an expected phase delay of the incoming RF signals to the measured phase delay of the incoming RF signals to identify a phase delay deviation indicating compromised integrity of the incoming RF signals indicative of a compromised integrity of the incoming RF signal. The metasurface hardware processor further executes code instructions of a metasurface hardware geofencing system and an integrated AI-based anomaly detection algorithm to detect a capacitance state of the incoming RF signal from the RDDN to, based on an impendence and reflection coefficient look-up table, remap a delay configuration corresponding to determining a dynamic phase delay to be introduced into the reflected RF signal by dynamically adjusting, based on iteratively remapped delay configurations. Then the metasurface hardware processor executes code instructions of a metasurface hardware geofencing system to use the capacitance load configuration determined at the RDDN to apply voltage adjustments to varactor circuit 563 at the surface reflective pattern resonant structures 561 of metasurface unit cells 560a to impart the determined dynamic phase delay to the reflected RF signal to secure the communication between the transmitter device and the receiver device according to embodiments herein.

A plurality of metasurface unit cells, such as 560a, may include a substrate integrated waveguide (SIW) 562 disposed between substrate sections 566a and 566b. The SIW 562 may include a ground plane 562a separating it from the substrate section 566a and a ground plane 562b separating it from the substrate section 566b. A plurality of conductive interconnects 562c may be disposed between the plural ground planes 562a and 562b to form an electromagnetically shielded SIW 562 embedded in the substrate 566a and 566b in embodiments herein to allow passage of a voltage line 565 formed through substrate 566b, the SIW 562, the ground plane 562a and the ground plane 562b, and substrate 566a to the reflective pattern resonant structure 561 that is reflecting the RF signal in embodiments herein. An electromagnetically coupled RF signal probe line 564a is formed through substrate 566b and the ground plane 562b and into SIW 562.

The electromagnetically coupled RF signal probe line 564a in an embodiment may be proximate to the voltage line 565 to be electromagnetically coupled to detect the incoming RF signals from the voltage line 565 from reflective pattern resonant structure 561 for a signal coupled readout pad 564b. The ground planes 562a and 562b in an embodiment and the plurality of conductive interconnects 562c may electrically isolate the electromagnetically coupled RF signal probe line 564a and the voltage line 565 within the substrate integrated waveguide 562 to minimize radiofrequency noise interference while detecting the incoming RF signal from the reflective pattern resonant structure 561 of the conductive material on the substrate. In an embodiment, the electromagnetically coupled RF signal probe line 564a may also be disposed sufficiently proximate to the voltage line 565 and of sufficient size inside the substrate integrated waveguide 562 to detect the incoming RF signal from the reflective pattern resonant structure 561 of conductive material on the substrate via coupling with voltage line 565.

In an embodiment, the signal coupled readout pad 564b may transmit the incoming RF signal to the reconfigurable delay detection network (RDDN) described in greater detail below with respect to FIG. 7 for determination of a measured time phase delay in the RF signal as it is reflected out for retransmission to the receiving device (e.g., an access point receiving an uplink RF signal or an endpoint information handling system receiving a downlink RF signal). The incoming RF signal may also be transmitted from the signal coupled readout pad 564b to a microcontroller or observed by such a microcontroller at the metasurface array including the metasurface unit cell 560a for determination of an angle of arrival across a plurality of metasurface unit cells, including 560a. The microcontroller of the metasurface array in an embodiment may then determine an expected time phase delay for the incoming RF signal, based on the measured angle of arrival, and compare this value to a measured time phase delay determined by the RDDN, as described in greater detail with respect to FIG. 7.

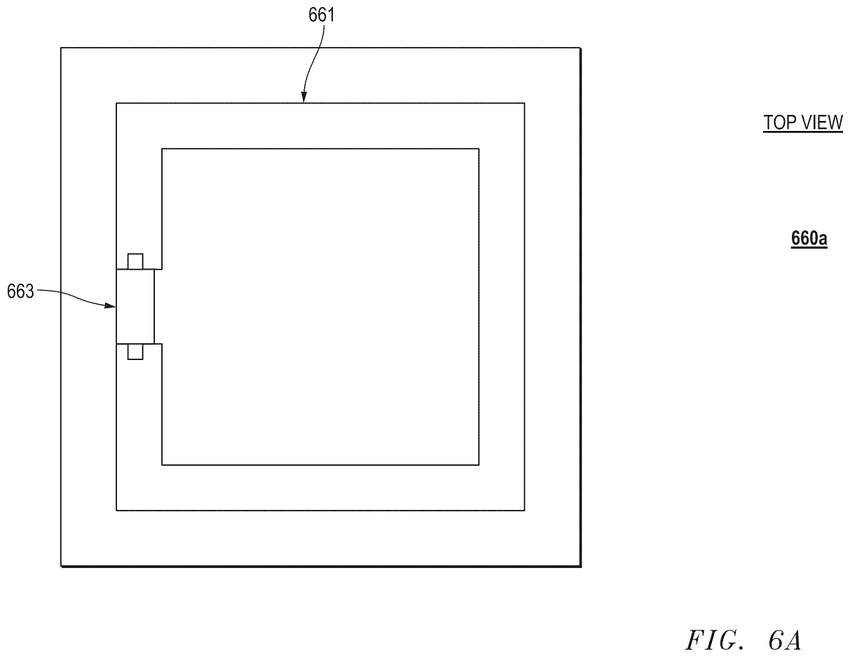

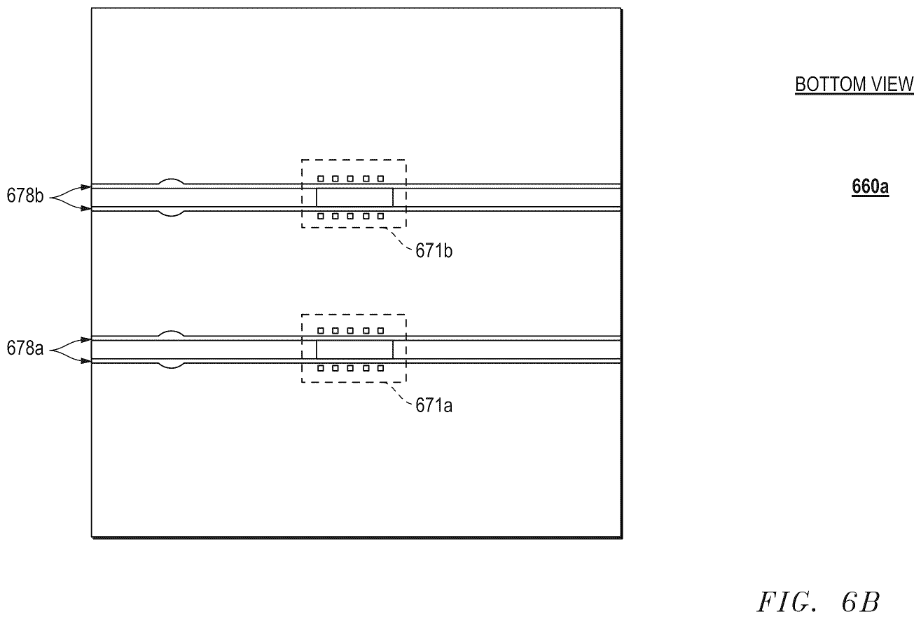

FIG. 6A is graphical diagram illustrating top view of a metasurface unit cell of a metasurface array for reflecting a RF transmission between a secure access point and an authorized endpoint information handling system according to an embodiment of the present disclosure. The metasurface unit cell 660a in an embodiment may be one of a plurality of metasurface unit cells for a metasurface array. Each of the metasurface unit cells, such as 660a, may include a reflective pattern resonant structure 661 of conductive material on a substrate to reflect the RF signals of a wireless link across a plurality of the metasurface unit cells, including 660a of the metasurface array between a transmitter device and a receiver device. The varactor diode 663 may tune the reflected RF signal in an embodiment for beamforming and directionality. In some specific embodiments, a voltage adjustment output may be transmitted through a voltage line (e.g., FIGS. 5, 565) at the metasurface unit cell 660a to the varactor 663 in order to apply the computed dynamic phase delay to the reflected RF signal as determined from the RDDN.

FIG. 6B is a graphical diagram illustrating a bottom view of a metasurface unit cell of a metasurface array for reflecting a RF transmission between a secure access point and an authorized endpoint information handling system according to an embodiment of the present disclosure. In an embodiment, a signal coupled readout pad (e.g., 564b of FIG. 5) of the metasurface unit cell 660a may transmit a captured incoming RF transmission coupled via an RF signal probe in an SIW to a reconfigurable delay detection network (RDDN) 671a or 671b disposed within the bottom surface of the metasurface unit cell 660a,. The RDDN 671a or 671b in an embodiment may have plural fixed transmission line segments along the RF transmission lines 678a and 678b with known and adjustable capacitance loads to determine a measured phase delay of the incoming RF signals and determine a dynamic adjusted phase delay to be imparted in reflected RF signals, as described in greater detail below with respect to FIG. 7.

FIG. 7 is graphical diagram illustrating a reconfigurable delay detection network (RDDN) 771 of a plurality of capacitors with known capacitance load at fixed transmission line segments across the bottom surface of a metasurface unit cell for measuring a time phase delay of a radiofrequency (RF) signal according to an embodiment of the present disclosure. As described herein, the incoming RF signal in an embodiment may be fed down an RF transmission line 778a of an RDDN 771 with known capacitance load at fixed transmission line segments across the RDDN 771. An RDDN 771 may be operably connected to each metasurface unit cell in an embodiment and may include RF transmission lines 778a operably connected to the metasurface unit cell via a signal coupled readout pad (e.g., 564a of FIG. 5) and RF pads 772a for one or more metasurface unit cells. Control pads 774a, 774b, 774c, 774d, 774e, 774f, 774g, and 774h within each RDDN 771 in an embodiment may be used to load or turn on or off a plurality of capacitors 776a, 776b, 776c, 776d, 776e, 776f, 776g, and 776h (formed into capacitor networks), respectively, embedded within each of the RF lines 778a to known capacitance values in order to generate impedance at each junction of capacitors 776a, 776b, 776c, 776d, 776e, 776f, 776g, and 776h, respectively, within the RF lines 778a. When the incoming RF uplink signal is input into one RF pad 772a to output RF pad 772b through the RDDN 771 in an embodiment, the control line 778b of the RDDN 771 may be measured relative to the resonance generated by the known capacitance values at the capacitor junctions 776a, 776b, 776c, 776d, 776e, 776f, 776g, and 776h, respectively along the RF lines 778a to generate a known time phase delay in the RF lines 778a.

The hardware processor at the metasurface array in an embodiment may be operatively coupled to the output RF pads 772b via a printed circuit board and may execute machine readable code instructions of the metasurface hardware based geofencing system to determine a measured time phase delay of the signal from the RDDN 771 at the metasurface unit cells based on the phase delay from the known capacitance load measured at RF lines 778a and the control line 778b. This measured time phase delay may then be compared to the expected time phase delay. The hardware-based measurement of resonance frequency may then be used to determine a hardware-based phase time delay for the incoming RF uplink signal at each of the plurality of metasurface unit cells. Because this determination is made based on the hardware measurements at the RDDN 771, this measured time phase delay may be incapable of spoofing and may require very little power expenditure and low computing overhead.

As described herein, with the comparison of the expected phase delay of the incoming RF signals to the measured phase delay of the incoming RF signals at RDDN 771 is used to identify a phase delay deviation indicating compromised integrity of the incoming RF signals. In other embodiments herein, the metasurface hardware processor of the metasurface unit cell array may also introduce a dynamic phase delay into a reflected RF signal. In an embodiment, the capacitance state of the RF signal at the RDDN 771 may be initially detected in order to, based on an impendence and reflection coefficient look-up table, iteratively remap a delay configuration with a capacitive load with switchable capacitors, such as capacitors 776a, 776b, 776c, 776d, 776e, 776f, 776g, and 776h, to impart phase delay in captured RF signals corresponding to a dynamic phase delay to be introduced into the reflected RF signal.

As described herein, the incoming RF signal is electromagnetically coupled from the reflective pattern resonant structure of each of the plurality of metasurface unit cells within the metasurface unit cell array. Each of these reflective pattern resonant structures are operatively coupled to the SIW that includes a RF signal probe that measures the phase shifts between consecutive metasurface unit cells and transmits that small portion of the incoming RF signal to the input RF pad 772a of an RDDN. The RDDN has known capacitance load at fixed transmission line segments across the RDDN via the currently active junctions of switchable capacitor networks 776a, 776b, 776c, 776d, 776e, 776f, 776g, and 776h. The metasurface hardware processor may detect this capacitance state of the incoming RF signal from the captured RF signal transmitted across the RDDN 771 to the output RF pad 772b and determine to iteratively readjust the impedance at one or more junctions of capacitors 776a, 776b, 776c, 776d, 776e, 776f, 776g, and 776h, respectively, within the RF lines 778a (or 778b) in order to concurrently adjust the phase of the detected captured RF signal sensed at the output RF pad 772b. The detected captured RF signal at the output RF pad 772b is also determined for signal loss from the impedance imparted by the capacitive load of switched junction of capacitors 776a, 776b, 776c, 776d, 776e, 776f, 776g, and 776h.

Thus, the effect of adjusting impedance of the capacitive load to generate a dynamic phase delay is iteratively tested to select a dynamic phase delay that also maintains a quality of the RF signal such that RF signal loss is less than a maximum signal loss threshold. In an embodiment, the metasurface hardware processor may utilize determination from, for example, a Smith chart to determine what levels of impedance can be imparted onto the RF signal within the RDDN and the individual junction of capacitors 776a, 776b, 776c, 776d, 776e, 776f, 776g, and 776h, respectively, without losing quality in the captured RF signal while still introducing a dynamic phase delay into the captured RF signal. This level of impedance may then be adjusted at the tunable varactor of a metasurface unit cell or group of metasurface unit cells to impart the determined phase delay into reflected RF signals that are to be reflected off of the surface of the metasurface unit cell array as a security measure. This determined phase delay is shared with the authorized transmitting and receiving devices in embodiments herein. This allows the metasurface hardware controller to dynamically impart, based on the iteratively remapped delay configurations from switched changes in the capacitance load configuration at the RDDN 771 to determine minimized signal loss, the dynamic phase delay to the reflected RF signal with the tunable varactor diode on each metasurface unit cell in order to secure the communication between the transmitter device and the receiver device.

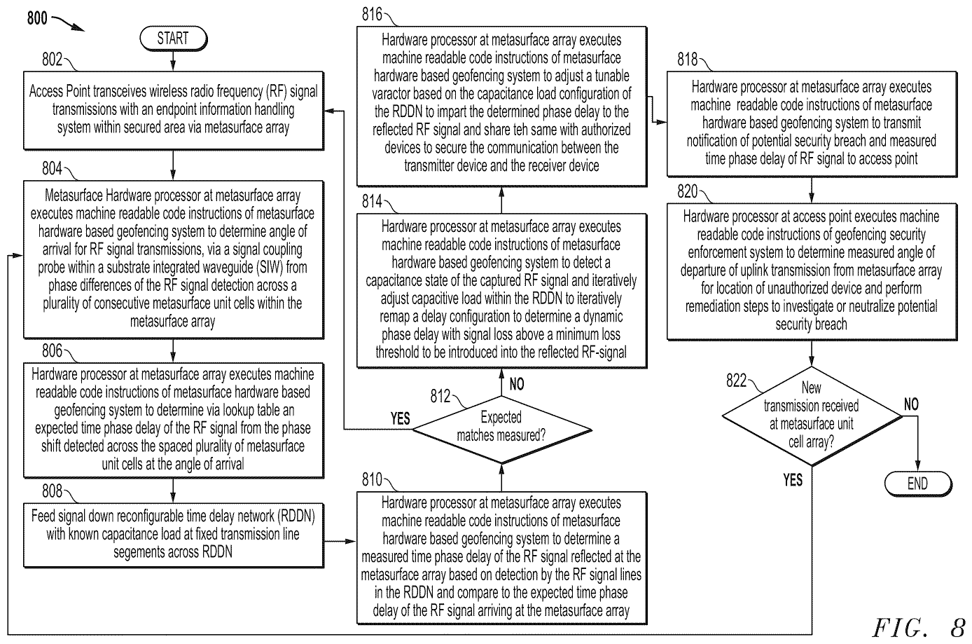

FIG. 8 is a flow diagram of a method for monitoring and detecting differences between a time phase delay for an incoming radio frequency (RF) uplink signal at a metasurface array that is estimated based upon angle of arrival of the RF signal and a hardware-based measured time phase delay for that RF signal to identify and inhibit unauthorized interception of the RF signal transmission of a wireless link as reflected by the metasurface array according to an embodiment of the present disclosure. As described herein, with the advent of massive multiple input multiple output (MIMO) wireless technologies, a group of antennas at both the transmitting device and receiving device may provide high spectral and energy efficient wireless communication systems. In an embodiment of the present disclosure, a series of thin surfaces or panels can be installed on building surfaces or other surfaces within a radiofrequency environment that may be used to steer these EM waves of an RF signal for a wireless link between a secured access point and an authorized endpoint information handling system.

At block 802, a network access point in an embodiment may transceive wireless RF signals with an authorized endpoint information handling system via a wireless link within a geofence secured area via a metasurface array. The metasurface array may be installed on building surfaces or other surfaces within a radiofrequency environment that may be used to steer these RF signals and expand wireless range or signal quality of wireless links and may include metasurface unit cells in an array in embodiments herein. The metasurface arrays of embodiments of the present disclosure may be used within current infrastructures having radiofrequency environments within, for example, office settings or home settings where radiofrequency data communication could benefit from these metasurfaces relaying EM wave transmissions around corners, into various office spaces, and/or into various rooms. The metasurface arrays in an embodiment may be in a fixed location designed to steer RF signals of a wireless link between a fixed-location secure access point and a fixed-location endpoint information handling system.

At block 804, a hardware processor at the metasurface array in an embodiment may execute machine readable code instructions of a metasurface hardware based geofencing system to determine an angle of arrival for an RF signal of a wireless link incoming from an authorized endpoint information handling system. This incoming RF signal may be an uplink received from the authorized endpoint information handling system or may be a downlink received from the secure access point in various embodiments. The angle of arrival may be determined based on differences in phase angle for the incoming transmission detected across one or more metasurface unit cells within the metasurface array that are used to steer the incoming RF signal to a fixed-location target. The target may be the secure access point in the case of an uplink or the authorized endpoint information handling system in the case of a downlink in some embodiments herein.

The metasurface hardware based geofencing system in an embodiment may determine a hardware-based angle of arrival via an electromagnetically coupled RF signal probe within an SIW that is embedded within a substrate of one or more metasurface unit cells of the metasurface array. The SIW in an embodiment may be situated between two dielectric substrates embedding two parallel conductive ground planes coupled with rows of metallic interconnects between the ground planes to enclose the SIW.

The electromagnetically coupled RF signal probe line in an embodiment may be coupled to a signal coupled readout pad. A voltage line is disposed through the SIW and the surrounding substrate to a reflective pattern resonant structure of conductive material disposed on the substrate for reflecting the incoming RF signal of the wireless link reflected at the metasurface array. The electromagnetically coupled RF signal probe line is sufficiently proximate and of sufficient size to be electromagnetically coupled to the voltage line within the SIW to detect the RF signals from the voltage line and transmit those RF signals to the signal coupled readout pad in an embodiment. The ground planes and the plurality of conductive interconnects may electrically isolate the electromagnetically coupled RF signal probe line during electromagnetic coupling with the voltage line within the SIW to minimize radiofrequency noise interference while detecting the incoming RF signal from the reflective pattern resonant structure of the conductive material on the substrate.

This allows a sample of the RF signal to be taken without significantly impacting retransmission of the RF signal of the wireless link to the intended target (e.g., the access point in the case of an uplink or the authorized endpoint information handling system in the case of a downlink). The sample of the incoming RF signal in an embodiment may be received at a probe signal readout pad, which may be operatively coupled to the hardware processor executing machine readable code instructions of the metasurface hardware based geofencing system along with signal readout pads from a plurality of consecutive metasurface unit cell with known distance spacing in the array. In an embodiment, the hardware processor executing machine readable code instructions of the metasurface hardware based geofencing system may use the sampled RF signal across the plurality of consecutive metasurface unit cells to determine an angle of arrival for the incoming RF signal of the wireless link. This angle of arrival is determined based on the known spacing and distance between the consecutive metasurface unit cells in the array and the time the RF signal is received at each consecutive metasurface unit cell in embodiments herein.

At block 806, the hardware processor at the metasurface array in an embodiment may execute machine readable code instructions of the metasurface hardware based geofencing system to determine, via lookup table, an expected time phase delay of the RF signal between each of the metasurface unit cells. This determination may be made based on the AoA previously determined at block 804. Because this determination is made based on the angle of arrival measured via the plural consecutive metasurface unit cells, this expected time phase delay may be incapable of spoofing and may require very little power expenditure and low computing overhead.

The incoming RF uplink signal in an embodiment at block 808 may be fed down a reconfigurable delay detection network (RDDN) with known capacitance load on an RF transmission line at fixed RF transmission line segments across the RDDN. A reconfigurable delay detection network may be operably connected to each metasurface unit cell in an embodiment and may include RF transmission lines operably connected to the signal coupled readout pad of the electromagnetically coupled RF signal probe line for at least one metasurface unit cell via RF input pads of the RDDN. Control pads within each reconfigurable delay detection network in an embodiment may be used to switch on or off a plurality of capacitors embedded within each of the RF transmission lines to known capacitance values in order to generate impedance at each junction of capacitors within the RF transmission lines to impart a known phase delay in the RF signal. Thus, when the incoming RF signal being reflected by the metasurface unit cell is fed from the input RF pad of the reconfigurable delay detection network down the capacitance loaded RF signal lines or control RF line to the output RF pad of the reconfigurable delay detection network, the control line of the reconfigurable delay detection network may measure delay relative to the capacitance loaded RF signal lines having known imparted delay due to the resonance frequency generated by the known capacitance values at the capacitor junctions at fixed spacing segments. In this way, a measured phase time delay of the RF signal may be made.

At block 810, the hardware processor at the metasurface array in an embodiment may execute machine readable code instructions of the metasurface hardware based geofencing system to determine a measured time phase delay of signal from the reconfigurable delay detection network (RDDN) at the metasurface unit cells from the output pads of the RDDN at block 808. This measured time phase delay may then be compared to the expected time phase delay determined from the angle of arrival determined from the plural consecutive metasurface unit cells. The hardware-based measured phase time delay for the incoming RF uplink signal from the RDDN at one or more of the plurality of metasurface unit cells reflecting the RF signal for the wireless link may be assessed for a deviation from the expected phase shift delay of the RF signal. Again, because this determination is made based on the hardware measurements at the RDDN, this measured time phase delay may be incapable of spoofing and may require very little power expenditure and low computing overhead.

It may be determined in an embodiment at block 812 whether the measured time phase delay of the RF signal reflected at the metasurface array determined at block 810 matches the expected time phase delay of the RF signal arriving at the metasurface array determined at block 806. As described herein, if an unauthorized device manages to steer the uplink RF signal toward themselves, rather than toward the access point, this will cause an additional time delay in the reflected RF signal that is unexpected but captured within the measurement of the time phase delay by the RDDN. Such an additional time delay in an embodiment may be detected by the measured time phase delay not matching the expected time phase delay. If the measured time phase delay of arrival determined at block 810 does not match the expected time phase delay of arrival determined at block 806, this may indicate potential outside interference with the RF signals of the wireless link being reflected via the metasurface array.

Where the measured time phase delay of arrival determined at block 810 does not match the expected time phase delay of arrival determined at block 806 the method 800 may proceed to block 814. At block 814, the metasurface hardware processor (e.g., metasurface hardware controller) executing machine readable code instructions of metasurface hardware based geofencing system to detect a capacitance state of the incoming RF signal from the RDDN to, based on an impendence and reflection coefficient look-up table, iteratively remap a delay configuration with switchable capacitor networks in the RDDN to determine a corresponding dynamic phase delay to be introduced into the reflected RF signal.

This allows the hardware processor at metasurface array to execute machine readable code instructions of metasurface hardware based geofencing system and integrated AI based anomaly detection algorithm to iteratively adjust, based on the remapped delay configuration imparted with the switched capacitance load configuration at the RDDN to apply the dynamic phase delay to the captured RF signals. The signal loss impact of the remapped delay configuration and the capacitance load configuration of the RDDN on the captured RF signal is iteratively determined to select the capacitive load having impedance that does not impact signal loss or does so within a maximum RF signal loss threshold level.

As described herein, the incoming RF signal is received at the reflective pattern resonant structure of each of the plurality of metasurface unit cells within the metasurface unit cell array. Each of these reflective pattern resonant structures are operatively coupled to the SIW that includes a RF signal probe that measures the phase shifts between consecutive metasurface unit cells and transmits that small portion of the incoming RF signal to an RF transmission line of an RDDN with known capacitance load at fixed transmission line segments across the RDDN via a signal coupled readout pad at each SIW. The metasurface hardware processor may detect this capacitance state of the incoming RF signal and determine how to readjust the impedance by iteratively readjusting one or more junctions of capacitors within the RF lines for capacitance load configurations in order to iteratively adjust the phase of the RF signal to determine if signal loss of the RF signal is less than a maximum signal loss threshold. In an example embodiment, the metasurface hardware processor may utilize, for example, a Smith chart that determines what levels of impedance can be imparted onto the captured RF signal within the RDDN via the individual junction of switchable capacitors respectively, without losing quality in the RF signal while still introducing a dynamic phase delay into the captured RF signal. This capacitance load configuration level of such a remapped delay configuration for an acceptable determined phase delay may then be used to adjust a tunable varactor capacitance for imparting the determined phase delay on a reflected RF signal to secure the communication between the transmitter device and the receiver device at block 816.

At block 816, after determining the dynamic phase delay to be used by selectively altering the phase delay of the captured RF signal by iteratively adjusting the switched circuit capacitance of RDDN switchable capacitive networks for determining the dynamic phase delay to the captured RF signal, the metasurface hardware processor may use the switched capacitive load to impart the determined dynamic phase delay to reflected RF signals at the metasurface unit cells. A voltage signal may be sent to a surface-mount device (SMD) tunable varactor diode integrated with the metasurface unit cells to impart the determined phase delay in reflected RF signals by the metasurface unit cell array without altering beam directionality in embodiments herein.

Again, in an embodiment, the capacitance state of the RF signal at the RDDN may be initially detected in order to, based on an impendence and reflection coefficient look-up table, iteratively remap a delay configuration corresponding to determine a dynamic phase delay to be introduced into the reflected RF signal. This allows the metasurface hardware controller to dynamically adjust, based on the remapped delay configuration for an acceptable determined phase delay, the tunable varactor at the reflective pattern resonant structure to apply the dynamic phase delay to the reflected RF signal at each metasurface unit cell in order to secure the communication between the transmitter device and the receiver device. The determined phase delay may also be shared, out of band or encrypted in band, with the authorized transmitter information handling system and authorized receiver information handling system, but not the unauthorized eavesdropping information handling system, in the radiofrequency environment. In this way, the metasurface unit cell array may secure RF signals reflected therefrom for wireless communications from uplink or downlink interception by an unauthorized eavesdropper information handling systems in embodiments herein.

This element-level phase shifting allows the beam to maintain its intended direction while subtly altering its propagation characteristics in time. The correction mechanism ensures the remapped signal maintains impedance compatibility as verified using a Smith Chart analysis, for example, thereby avoiding signal loss due to impedance mismatches. This technique renders the communication path unpredictable and unintelligible to the unauthorized intercepting device, effectively preventing uplink and downlink interception.

Additionally, where the measured time phase delay of arrival determined at block 810 does not match the expected time phase delay of arrival determined at block 806 the method 800 may also include additional security measures described at block 818 for notifying the access point of such a potential security breach and prompting potential mitigation efforts to address that breach. If the measured time phase delay determined at block 810 matches the expected time phase delay of arrival determined at block 806, this may confirm a lack of interference with the RF signal of the wireless link being reflected by the metasurface array. In such a case, there may be no need to notify the access point of a potential security breach, and the method may return to block 802 for continued transceiving of RF signals between the access point and the authorized endpoint information handling system via the metasurface array. By repeating the loop between blocks 802 and 812 in such a way, the hardware processor at the metasurface array executing machine readable code instructions of the metasurface hardware based geofencing system may continuously scan for and identify attempts to obscure unauthorized interception of RF signals between the access point and the authorized endpoint information handling system within the geofence secured area.

In an embodiment at block 818 in which the measured time phase delay determined at block 810 does not match the expected time phase delay of arrival determined at block 806, the hardware processor at the metasurface array may execute machine readable code instructions of the metasurface hardware based geofencing system to transmit notification that the measured time phase delay does not match the expected time phase delay. This notification may also include the measured time phase delay or the deviation from the expected time phase delay of the RF signal for the wireless link with a target device. This measured time phase delay or deviation from expected time phase delay of the RF signal may be used to determine a true angle of departure of the uplink signal toward the unauthorized user, and consequently to identify the physical location or direction of the unauthorized device with respect to the metasurface array or the receiving or transmitting devices in the geofenced, secured wireless space in an embodiment.

At block 820, the hardware processor at the access point in an embodiment may execute machine readable code instructions of a geofencing security enforcement system to perform remediation steps to investigate or neutralize potential security breach. This may include terminating RF signals between the access point and the authorized endpoint information handling system, powering down the metasurface array, or physically locking down the geofence secured area, for example. In other examples, the access point may provide an information technology decision maker (ITDM) with an estimated location of the unauthorized device with respect to the metasurface array, based on the determined angle of departure of the uplink from the metasurface array to the unauthorized device. This may allow the ITDM to deploy security personnel to that location to disable any unauthorized devices. In such a way, the hardware processor of the metasurface array executing code instructions of the metasurface hardware based geofencing system may work in tandem with a reconfigurable delay detection network at least one metasurface unit cell of the metasurface array to determine and compare an estimated, expected time phase delay made based on a measured angle of arrival across plural metasurface unit cells and a hardware-based measurement of measured time phase delay for an RF uplink signal reflected at a metasurface array via the RDDN to monitor and inhibit unauthorized devices from intercepting the RF uplink.

At block 822, the method 800 may further include determining if a new transmission is received at the metasurface unit cell array. Where a new transmission is detected, the method 800 may return back to block 804 for the metasurface hardware based geofencing system to determine angle of arrival for RF signal transmissions, via a signal coupling probe within a substrate integrated waveguide (SIW) from phase differences of the RF signal detection across a plurality of consecutive metasurface unit cells within the metasurface array as described herein. Where no new transmission is received as determined at block 822, the method 800 for monitoring and detecting differences between a time phase delay for an incoming radio RF uplink signal at a metasurface array that is expected based upon angle of arrival of the RF signal and a hardware-based measured time phase delay for that RF signal as reflected by the metasurface to identify and inhibit unauthorized interception of the transmission may then end.

The processes or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A metasurface unit cell array to manipulate reflection of incoming radiofrequency (RF) signals comprising:
a plurality of metasurface unit cells each including a reflective pattern resonant structure of conductive material on a substrate to reflect the RF signals of a wireless link across the metasurface unit cell array between a transmitter device and a receiver device;
a substrate integrated waveguide in the substrate of each metasurface unit cell disposed below the reflective pattern resonant structure and formed between plural ground planes with a plurality of conductive interconnects between the plural ground planes;
a voltage line formed through the substrate and the substrate integrated waveguide of each metasurface unit cells to the reflective pattern resonant structure on the substrate;
an electromagnetically coupled RF signal probe line formed through the substrate and a first ground plane of each metasurface unit cell and into the substrate integrated waveguide to detect the incoming RF signals from the voltage line for a signal coupled readout pad;
the signal coupled readout pad to transmit the incoming RF signals to a reconfigurable delay detection network (RDDN) having plural fixed transmission line segments with known capacitance loads to determine measured phase delay of the incoming RF signals; and
a metasurface hardware controller operably coupled to the plurality of metasurface unit cells executing code instructions of a metasurface hardware geofencing system to:
compare an expected phase delay of the incoming RF signals, determined via an angle of arrival of the RF signals across plural consecutive metasurface unit cells, to the measured phase delay of the incoming RF signals to identify a phase delay deviation indicating compromised integrity of the incoming RF signals indicative of a compromised integrity of the incoming RF signals;
detect a capacitance state of the incoming RF signal from the RDDN and iteratively remap a phase delay configuration with a switchable capacitive load at the RDDN to determine a corresponding dynamic phase delay to be introduced into a reflected RF signal at the metasurface unit cells;
dynamically adjust, based on the remapped delay configuration for the determined dynamic phase delay, the capacitance at a tunable varactor of the metasurface unit cells to impart the determined dynamic phase delay to the reflected RF signal to secure the communication between the transmitter device and the receiver device.

2. The metasurface unit cell array of claim 1 further comprising:
the metasurface hardware controller executing code instructions of the metasurface hardware geofencing system to iteratively switch the switchable capacitance load along the RF signal line of the RDDN and measure incoming RF signal loss at the RDDN to determine that the incoming RF signal loss is less than a maximum signal loss threshold for the dynamic phase delay to be introduced into the reflected RF signal at the metasurface unit cells.

3. The metasurface unit cell array of claim 1 further comprising:
the RDDN having plural fixed transmission line segments along the RF signal line includes switchable capacitance networks at junctions of the plural fixed transmission line segments for iteratively switching the switchable capacitance load to iteratively remap the phase delay configuration to determine the dynamic phase delay to be introduced into the reflected RF signal at the metasurface unit cells.

4. The metasurface unit cell array of claim 1 further comprising:
the metasurface hardware controller transmits a notification of compromised integrity of the incoming RF signals and the determined dynamic phase delay introduced into the reflected RF signal at the metasurface unit cells to a transmitter device and a receiver device in a radiofrequency environment, via a wireless antenna, upon identifying the phase delay deviation of the incoming RF signals.

5. The metasurface unit cell array of claim 1 further comprising:
the metasurface hardware controller executing code instructions of the metasurface hardware geofencing system including a generative adversarial network (GAN) algorithm of an integrated AI-based anomaly detection algorithm to iteratively switch the switchable capacitive load at the RDDN to determine the dynamic phase delay to be introduced into the reflected RF signal at the metasurface unit cells based on the incoming RF signal frequency, capacitance of the switchable capacitive load, and the signal loss of the incoming RF signal from RF output pads of the RDDN to determine the voltage signal to transmit to the tunable varactor of the metasurface unit cells to impart the determined dynamic phase delay to the reflected RF signal.

6. The metasurface unit cell array of claim 1, wherein plural ground planes and the plurality of conductive interconnects electrically isolate the electromagnetically coupled RF signal probe line and the voltage line within the substrate integrated waveguide to minimize radiofrequency noise interference while detecting the incoming RF signal from the reflective pattern resonant structure of conductive material on the substrate.

7. The metasurface unit cell array of claim 1 further comprising:
the metasurface hardware controller operably coupled to the plurality of metasurface unit cells executing code instructions of the metasurface hardware geofencing system to compare the expected phase delay of the incoming RF signals to the measured phase delay of the incoming RF signals to identify a match and that no phase delay deviation indicates the compromised integrity of the incoming RF signals and the metasurface hardware controller keeps the wireless link intact.

8. The metasurface unit cell array of claim 1, wherein the electromagnetically coupled RF signal probe line is disposed sufficiently proximate to the voltage line in the substrate integrated waveguide to detect and capture a portion of the incoming RF signal from the reflective pattern resonant structure of conductive material on the substrate and transmit that captured portion of the incoming signal to an RF input pad of the RDDN.

9. A metasurface unit cell array of a plurality of metasurface unit cells used to manipulate reflection of incoming radiofrequency (RF) signals of a wireless link between a transmitter device and a receiver device comprising:
a reflective pattern resonant structure of conductive material on a substrate to reflect the incoming RF signals and a substrate integrated waveguide in the substrate disposed below the reflective pattern resonant structure and formed between plural ground planes with a plurality of conductive interconnects between the plural ground planes;
a voltage line formed through the substrate and the substrate integrated waveguide to the reflective pattern resonant structure on the substrate;
an electromagnetically coupled RF signal probe line formed through the substrate and a first ground plane and into the substrate integrated waveguide to detect the incoming RF signals from the voltage line for a signal coupled readout pad;
the signal coupled readout pad to transmit the incoming RF signals to a reconfigurable delay detection network (RDDN) having plural fixed transmission line segments with known capacitance load to determine measured phase delay of the incoming RF signals;
a metasurface hardware controller operably coupled to the metasurface unit cell executing code instructions of a metasurface hardware geofencing system to compare an expected phase delay of the incoming RF signals and determine an angle of arrival determined from the RF signal received from plural consecutive metasurface unit cells to the measured phase delay of the incoming RF signals to identify a phase delay deviation indicating compromised integrity of the incoming RF signals; and
the metasurface hardware controller executing code instructions of a metasurface hardware geofencing system to detect the incoming RF signal from the RDDN and iteratively remap a phase delay configuration with a switchable capacitive load at the RDDN to determine a corresponding a dynamic phase delay to be introduced into a reflected RF signal at the metasurface unit cells and to transmit a voltage signal, based on the remapped delay configuration for the determined dynamic phase delay, to a tunable varactor of the metasurface unit cells to impart the determined dynamic phase delay to the reflected RF signal to secure the communication between the transmitter device and the receiver device.

10. The metasurface unit cell array of claim 9 further comprising:
the RDDN having plural fixed transmission line segments along the RF signal line includes switchable capacitance networks at junctions of the plural fixed transmission line segments for iteratively switching the switchable capacitance load to iteratively remap the phase delay configuration to determine the dynamic phase delay to be introduced into the reflected RF signal at the metasurface unit cells.

11. The metasurface unit cell array of claim 9 further comprising:
the metasurface hardware controller executing code instructions of the metasurface hardware geofencing system to iteratively switch the switchable capacitance load along the RF signal line of the RDDN to iteratively remap the phase delay configuration and measure incoming RF signal loss and determine that the incoming RF signal loss is less than a maximum signal loss threshold for the dynamic phase delay to select the dynamic phase delay to be introduced into the reflected RF signal at the metasurface unit cells.

12. The metasurface unit cell array of claim 9 further comprising:
the metasurface hardware controller transmits a notification of compromised integrity of the incoming RF signals and the determined dynamic phase delay introduced into the reflected RF signal at the metasurface unit cells to the transmitter device and the receiver device in a radiofrequency environment, via a wireless antenna, upon identifying the phase delay deviation of the incoming RF signals.

13. The metasurface unit cell array of claim 9 further comprising:
the metasurface hardware controller executing code instructions of the metasurface hardware geofencing system to transmit the voltage signal to the tunable varactor of the metasurface unit cells to impart the determined dynamic phase delay to the reflected RF signal at the metasurface unit cells without adjusting a beam directionality.

14. The metasurface unit cell array of claim 9, wherein the electromagnetically coupled RF signal probe line is disposed sufficiently proximate to the voltage line in the substrate integrated waveguide to detect and capture a portion of the incoming RF signal from the reflective pattern resonant structure of conductive material on the substrate and transmit that captured portion of the incoming signal to an RF input pad of the RDDN.

15. A metasurface unit cell array of a plurality of metasurface unit cells to manipulate reflection of incoming radiofrequency (RF) signals of a wireless link between a transmitter device and a receiver device comprising:
a metasurface hardware controller executing code instructions of a metasurface hardware geofencing system to identify an angle of arrival of the incoming RF signals across plural signal coupled readout pads of consecutive metasurface unit cells in the metasurface unit cell array to determine an expected phase delay of the incoming RF signals;
each metasurface unit cell including a reflective pattern resonant structure of conductive material on a substrate, a substrate integrated waveguide embedded in the substrate of each metasurface unit cell disposed below the reflective pattern resonant structure and formed between a top ground plane and a bottom ground plane with a plurality of conductive interconnects between the top ground plane and the bottom ground plane around the substrate integrated waveguide, a voltage line formed through the substrate integrated waveguide to the reflective pattern resonant structure, and an electromagnetically coupled RF signal probe line formed a bottom ground plane and into the substrate integrated waveguide to detect the incoming RF signals from the voltage line within the substrate integrated waveguide for a signal coupled readout pad;
the metasurface hardware controller executing code instructions of a metasurface hardware geofencing system to detect a measured phase delay of the incoming RF signals from a reconfigurable delay detection network (RDDN) having plural fixed transmission line segments with known capacitance load to determine the measured phase delay of the detected incoming RF signals received from at least one metasurface unit cell and to compare an expected phase delay of the incoming RF signals and determine an angle of arrival determined from the RF signal received from plural consecutive metasurface unit cells to the measured phase delay of the incoming RF signals to identify a phase delay deviation indicating compromised integrity of the incoming RF signals;
the metasurface hardware controller executing code instructions of a metasurface hardware geofencing system to detect the incoming RF signal from the RDDN and iteratively switch a switchable capacitive load at the RDDN to determine a corresponding a dynamic phase delay to be introduced into a reflected RF signal at the metasurface unit cells and to transmit a voltage signal to a tunable varactor of the metasurface unit cells to impart the determined dynamic phase delay to the reflected RF signal; and
the metasurface hardware controller transmits a notification of the determined dynamic phase delay introduced into the reflected RF signal to the transmitter device and the receiver device, via a wireless antenna, upon identifying the phase delay deviation of the incoming RF signals to secure the communication between the transmitter device and the receiver device.

16. The metasurface unit cell array of claim 15 further comprising:
the metasurface hardware controller executing code instructions of the metasurface hardware geofencing system to iteratively switch the switchable capacitance load along the RF signal line of the RDDN and measure an incoming RF signal loss level at the RDDN to determine that the incoming RF signal loss is less than a maximum signal loss threshold for the dynamic phase delay to be introduced into the reflected RF signal at the metasurface unit cells.

17. The metasurface unit cell array of claim 15 further comprising:
the RDDN having plural fixed transmission line segments along the RF signal line includes switchable capacitance networks at junctions of the plural fixed transmission line segments for iteratively switching the switchable capacitance load to iteratively remap a phase delay configuration to determine the dynamic phase delay to be introduced into the reflected RF signal at the metasurface unit cells.

18. The metasurface unit cell array of claim 15, wherein the electromagnetically coupled RF signal probe line is disposed sufficiently proximate to the voltage line in the substrate integrated waveguide to detect and capture a portion of the incoming RF signal from the reflective pattern resonant structure of conductive material on the substrate and transmit that captured portion of the incoming signal to an RF input pad of the RDDN.

19. The metasurface unit cell array of claim 15 further comprising:
the metasurface hardware controller executing code instructions of the metasurface hardware geofencing system to transmit the voltage signal to the tunable varactor of the metasurface unit cells to impart the determined dynamic phase delay to the reflected RF signal at the metasurface unit cells without adjusting a beam directionality towards the receiver device.

20. The metasurface unit cell array of claim 15 further comprising:
the metasurface hardware controller executing code instructions of the metasurface hardware geofencing system including a generative adversarial network (GAN) algorithm of an integrated AI-based anomaly detection algorithm to iteratively switch the switchable capacitive load at the RDDN to determine the dynamic phase delay to be introduced into the reflected RF signal at the metasurface unit cells from the captured RF signal frequency, capacitance of the switchable capacitive load, and signal loss of the incoming RF signal measured from RF output pads of the RDDN to determine the voltage signal to transmit to the tunable varactor of the metasurface unit cells to impart the determined dynamic phase delay to the reflected RF signal.
